(19) United States
(12) Patent Application Publication
(10) Pub. No.: US 2025/0378814 A1
(43) Pub. Date: Dec. 11, 2025

(54) DEREVERBERATION FOR AUDIO SIGNALS VIA MACHINE LEARNING AND/OR USER CONTROL

(71) Applicant: SHURE ACQUISITION HOLDINGS, INC., Niles, IL (US)

(72) Inventors: Zhen Qin, Chicago, IL (US); Iris Lorente, Park Ridge, IL (US); Michael Lester, Buena Vista, CO (US); Yuanheng Yan, Chicago, IL (US); Wenshun Tian, Palatine, IL (US)

(21) Appl. No.: 19/234,854

(22) Filed: Jun. 11, 2025

Related U.S. Application Data
(60) Provisional application No. 63/658,646, filed on Jun. 11, 2024.

(51) Int. Cl. G10K 11/178

(52) U.S. Cl. CPC G10K 11/1785; G10K 11/1783; G10K 2210/3038; G10K 2210/505

(57) ABSTRACT

Techniques are disclosed herein for providing dereverberation for audio signals via machine learning and/or user control. Examples may include generating an audio feature set for an audio signal captured via a capture device positioned within an audio environment, inputting the audio feature set to a dereverberation neural network model configured to generate an audio dereverberation mask associated with the audio signal, inputting the audio feature set to a reverberation time estimation model configured to generate reverberation time data associated with the audio signal, and/or generating a dereverberation audio signal based at least in part on the audio dereverberation mask and the reverberation time data.

### CROSS REFERENCE TO RELATED APPLICATIONS

This application claims the benefit of U.S. Provisional Patent Application No. 63/658,646, titled “DEREVERBERATION FOR AUDIO SIGNALS VIA MACHINE LEARNING AND/OR USER CONTROL,” and filed on Jun. 11, 2024, the entirety of which is hereby incorporated by reference.

### TECHNICAL FIELD

Embodiments of the present disclosure relate generally to audio processing and, more particularly, to systems configured to provide dereverberation functionality for audio signals via machine learning, digital signal processing, and/or user control.

### BACKGROUND

A microphone system may employ one or more microphones to capture audio from an audio environment. Applicant has identified a number of deficiencies of using a microphone system to capture desirable audio and/or video content.

### BRIEF SUMMARY

Various embodiments of the present disclosure are directed to apparatuses, systems, methods, and computer readable media for providing dereverberation for audio signals via machine learning and/or user control. These characteristics as well as additional features, functions, and details of various embodiments are described below. The claims set forth herein further serve as a summary of this disclosure.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example audio signal processing system in accordance with one or more embodiments disclosed herein;

FIG. 2 illustrates an example audio signal processing apparatus configured in accordance with one or more embodiments disclosed herein;

FIG. 3 illustrates another example audio signal processing system in accordance with one or more embodiments disclosed herein;

FIG. 4 illustrates yet another example audio signal processing system in accordance with one or more embodiments disclosed herein;

FIG. 5 illustrates yet another example audio signal processing system in accordance with one or more embodiments disclosed herein;

FIG. 6 illustrates an example reverberation time (RT) estimation neural network model in accordance with one or more embodiments disclosed herein;

FIG. 7 illustrates an example dereverberation data flow in accordance with one or more embodiments disclosed herein;

FIG. 8 illustrates an example system associated with reverberation time estimation in accordance with one or more embodiments disclosed herein;

FIG. 9 illustrates an example mask calculation data flow in accordance with one or more embodiments disclosed herein;

FIG. 10 illustrates an example mask exponentiation data flow in accordance with one or more embodiments disclosed herein;

FIG. 11 illustrates an example residual scaling data flow in accordance with one or more embodiments disclosed herein;

FIG. 12 illustrates an example system in accordance with one or more embodiments disclosed herein;

FIG. 13 illustrates an example combined machine learning data flow in accordance with one or more embodiments disclosed herein;

FIG. 14 illustrates an example level compensation data flow in accordance with one or more embodiments disclosed herein;

FIG. 15 illustrates an example compensation control data flow in accordance with one or more embodiments disclosed herein;

FIG. 16 illustrates an example combined machine learning data flow in accordance with one or more embodiments disclosed herein;

FIG. 17 illustrates an example failsafe system associated with separate audio threading in accordance with one or more embodiments disclosed herein;

FIG. 18 illustrates an example audio processing control user interface in accordance with one or more embodiments disclosed herein; and

FIG. 19 illustrates an example method for providing dereverberation for audio signal via machine learning and/or user control in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

### Overview

Various embodiments of the present disclosure address technical problems associated with accurately, efficiently and/or reliably removing or suppressing reverberation, noise, acoustic feedback, and/or other undesirable characteristics associated with an audio signal. The disclosed techniques may be implemented by an audio signal processing system to provide improved audio signal quality.

Reverberation, noise, acoustic feedback, and/or other undesirable audio characteristics are often introduced during audio capture operations related to microphones, telephone conversations, video chats, office conferencing scenarios, lecture hall microphone systems, broadcasting microphone systems, augmented reality applications, virtual reality applications, in-ear monitoring systems, sporting events, live performances, and music or film production scenarios, etc.

Such reverberation, noise, acoustic feedback, and/or other undesirable audio characteristics affect intelligibility of speech and may produce other undesirable audio experiences for listeners. For example, when microphones are placed in a room intended for voice communication, the desired audio is the speech from the mouth of the person. However, the speech acoustic signal travels spherically and thus will additionally bounce of surfaces in the room and eventually reach the microphone at different times and/or intensities. The delayed, attenuated, and filtered versions of the speech are called reverberation. Reverberation reduces the intelligibility of the speech and is generally undesirable, especially in large quantities that affect intelligibility of speech and/or produce other undesirable audio experiences for listeners.

Various examples disclosed herein provide an audio signal processing system configured for providing dereverberation for audio signals via machine learning. The audio signal processing system may be configured for enabling a user to modify and/or control a degree of the dereverberation for the audio signals. As such, an enhanced audio signal with a desirable degree of reverberation for a listener may be provided.

In some examples, a low latency implementation of dereverberation may be provided as compared to less desirable dereverberation techniques. The dereverberation may be integrated into a signal path and designed with failsafe functionality to allow disablement of the dereverberation if a required processing time is not satisfied for digital signal processing. Additionally, user control may prioritize speech quality, balance between speech and reverb removal, or maximizing reverberation removal. The control may be realized via post-processing of machine learning model output.

In some examples, performance of the audio signal processing system may be improved by determining a real-time reverberation time prediction for an audio signal that may then be utilized to adjust intensity of the dereverberation for the audio signal. Accordingly, an audio experience for an audio environment with reverberation may be transformed into a desirable audio experience with audio that retains natural quality while minimizing reverberation.

### Exemplary Audio Processing Systems and Methods for Providing Dereverberation for Audio Signals Via Machine Learning and/or User Control

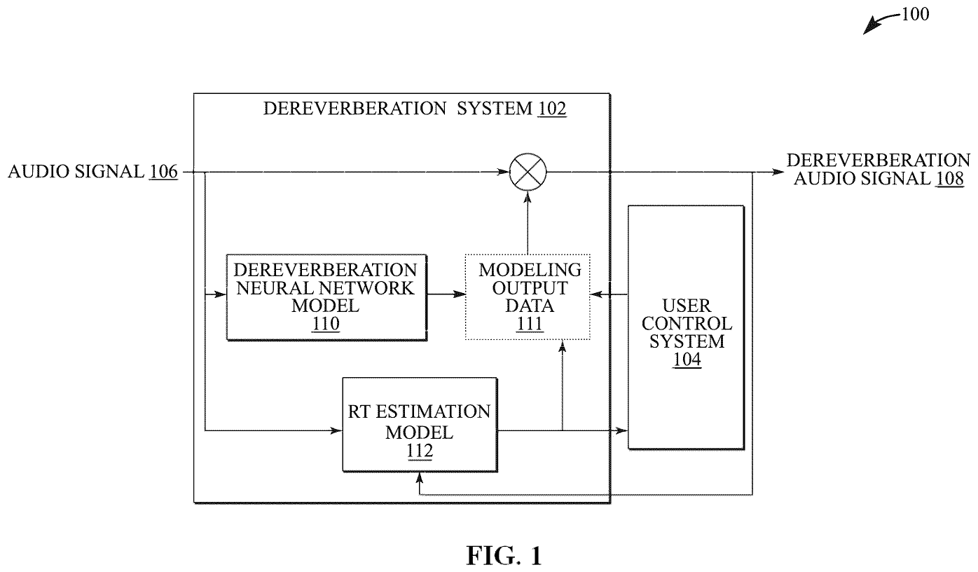

FIG. 1 illustrates an audio signal processing system 100 that is configured to provide dereverberation for audio signals via machine learning and/or user control, according to one or more embodiments of the present disclosure. The audio signal processing system 100 may enable a desirable quality and/or user control for dereverberation associated with audio signals. Additionally, the audio signal processing system 100 may enable a low latency implementation for providing dereverberation for audio signals. The low latency implementation for providing the dereverberation may also be well-integrated into a signal processing path for the audio signals to further enable the reduction of additional noise, acoustic feedback, and/or other undesirable audio associated with the audio signals.

To further enhance the dereverberation, the audio signal processing system 100 may provide failsafe functionality associated with the dereverberation to further enable a low latency implementation of the signal processing path with computation robustness such that the dereverberation is not applied to the audio signal in an event of misses in the computational timing and/or certain processing errors with respect to the dereverberation audio processing.

The audio signal processing system 100 may be a microphone system, a conferencing system (e.g., a conference audio system, a video conferencing system, a digital conference system, etc.), an audio performance system, an audio recording system, a music performance system, a music recording system, a digital audio workstation, a lecture hall microphone systems, a broadcasting microphone system, a sporting event audio system, an augmented reality system, a virtual reality system, an online gaming system, or another type of audio system. Additionally, the audio signal processing system 100 may be implemented as an audio signal processing apparatus and/or as software that is configured for execution on a smartphone, a laptop, a personal computer, a digital conference system, a wireless conference unit, an audio workstation device, an augmented reality device, a virtual reality device, a recording device, a microphone, headphones, earphones, speakers, or another device. The audio signal processing system 100 disclosed herein may be integrated into a virtual audio processing system (e.g., audio processing via virtual processors or virtual machines) with other conference audio processing.

In some examples, the audio signal processing system 100 may be integrated into an audio processing software application or a digital signal processor (DSP) module associated with an audio processing software application. In some examples, the audio signal processing system 100 may be integrated within an advanced DSP system that continually adapts to the acoustic characteristics in an audio environment, thereby providing optimal reverberation reduction without sacrificing speech clarity.

The audio signal processing system 100 may be adapted to produce improved audio signals with reduced reverberation, noise, acoustic feedback, and/or other undesirable audio artifacts even in view of exacting audio latency requirements. In applications focused on reducing reverberation, such reduced dereverberation may be provided with other signal processing such as, for example, noise reduction, denoising, acoustic echo cancellation, equalization, etc. Additionally, the audio signal processing system 100 may provide improved audio quality for audio signals in an audio environment. For example, the audio signal processing system 100 may provide clear and optimally configured audio for various types of audio environments. An audio environment may be an indoor environment, an outdoor environment, an entertainment environment, a room, a conference room, a meeting room, a classroom, a lecture hall, a performance hall, a broadcasting environment, a sports stadium or arena, a virtual environment, an automobile environment, or another type of video environment.

In some examples, the audio signal processing system 100 may be configured to remove or suppress reverberation, noise, acoustic feedback, and/or other undesirable sound from audio signals via a combination of machine learning modeling, digital signal processing, and/or user control. The audio signal processing system 100 and/or one or more other aspects disclosed herein may also utilize real-time measurements associated with an audio environment to provide the improved dereverberation for audio signal processing.

The audio signal processing system 100 may be configured to remove reverberation, noise, acoustic feedback, and/or other undesirable sound from speech-based audio signals captured within an audio environment. For example, an audio processing system may be incorporated into microphone hardware for use when a microphone is in a “speech” mode. The audio signal processing system 100 may alternatively be employed for another type of sound enhancement application such as, but not limited to, real-time dereverberation processing, active noise cancelation, adaptive noise cancelation, etc. In some examples, the audio signal processing system 100 may remove reverberation, noise, acoustic feedback, and/or other audio artifacts from non-speech audio signals such as music, precise audio analysis applications, public safety tools, sporting event audio, or other non-speech audio.

The audio signal processing system 100 includes a dereverberation system 102. The dereverberation system 102 is configured to perform at least dereverberation audio processing with respect to an audio signal 106 to generate a dereverberation audio signal 108. In some examples, the dereverberation system 102 is additionally configured to perform denoising, audio isolation, acoustic feedback filtering, speech removal, and/or other filtering of sound with respect to the audio signal 106 to generate the dereverberation audio signal 108. As illustrated in FIG. 1, the dereverberation system 102 includes a dereverberation neural network model 110 and/or a reverberation time (RT) estimation model 112 to enable the dereverberation audio processing with respect to an audio signal 106. In some examples, the RT estimation model 112 is a neural network model (e.g., an RT estimation neural network model). In other examples, the RT estimation model 112 is a DSP model.

The audio signal 106 received by the dereverberation system 102 may be captured via one or more capture devices within an audio environment. The one or more capture devices may include one or more sensors configured for capturing audio by converting sound into one or more electrical signals. The audio captured by the one or more capture devices may also be converted into the audio signal 106. The audio signal 106 may be digital audio or, alternatively, analog audio. In some examples, the audio signal 106 may be pre-processed by an audio codec.

The one or more capture devices may correspond to and/or comprise one or more microphones. For example, the one or more capture devices may correspond to a microphone array, one or more microphones of a microphone array, one or more linear microphone arrays, one or more ceiling microphone arrays, one or more table microphone arrays, one or more condenser microphones, one or more micro-electromechanical systems (MEMS) microphones, one or more dynamic microphones, one or more piezoelectric microphones, one or more virtual microphones, one or more network microphones, one or more ribbon microphones, one or more ambisonics microphones, or another type of microphone configured to capture audio. In some examples, the one or more capture devices include a plurality of multi-lobe capture devices. In some examples, the one or more capture devices generate and/or utilize one or more beamformed lobes to enable capture of audio. However, it is to be appreciated that, in certain examples, the one or more capture devices may include one or more video capture devices, one or more infrared capture devices, one or more sensor devices, and/or one or more other types of audio capture devices.

The dereverberation audio signal 108 may include audio with minimized or removed reverberation. For example, the dereverberation audio signal 108 may be a dereverberated version of the audio signal 106 such that reverberation is mitigated or removed from the audio signal 106. In some examples, the dereverberation audio signal 108 may be a full-band audio version of the audio signal 106 with removed or suppressed reverberation, noise, and/or audio artifacts related to undesirable sound. For example, the audio signal 106 may be associated with reverberated audio data and the dereverberation audio signal 108 may be associated with dereverberated audio data. In another example, the audio signal 106 may be associated with reverberated and noisy audio data and the dereverberation audio signal 108 may be associated with dereverberated and denoised audio data.

To enable generation of the dereverberation audio signal 108, the dereverberation system 102 may generate an audio feature set for the audio signal 106. In some examples, the audio feature set may be input to the dereverberation neural network model 110. The audio feature set may include one or more audio features for the audio signal 106. The audio features may represent physical features and/or perceptual features related to the audio signal 106. For instance, the one or more audio features may comprise: one or more: audio spectrum features, magnitude features, phase features, pitch features, harmonic features, Mel-frequency cepstral coefficients (MFCC) features, performance features, performance sequencer features, tempo features, time signature features, and/or other types of features associated with the audio signal 106.

The magnitude features may represent physical features of the audio signal 106 such as magnitude measurements with respect to the audio signal 106. The phase features may represent physical features of the audio signal 106 such as phase measurements with respect to the audio signal 106. The pitch features may represent perceptual features of the audio signal 106 such as frequency characteristics related to pitch for the audio signal 106. The harmonic features may represent perceptual features of the audio signal 106 such as frequency characteristics related to harmonics for the audio signal 106.

The MFCC features may represent physical features of the audio signal 106 such as MFCC measurements with respect to the audio signal 106. The MFCC measurements may be extracted based on windowing operations, digital transformations, and/or warping of frequencies on a Mel frequency scale with respect to the audio signal 106.

The performance features may represent perceptual features of the audio signal 106 such as audio characteristics related to performance of the audio signal 106. In some examples, the performance features may be obtained via one or more audio analyzers that analyze performance of the audio signal 106. The performance sequencer features may represent perceptual features of the audio signal 106 such as audio characteristics related to performance of the audio signal 106 as determined by one or more audio sequencers that analyze characteristics of the audio signal 106.

The tempo features may represent perceptual features of the audio signal 106 such as beats per minute characteristics related to tempo for the audio signal 106. The time signature features may represent perceptual features of the audio signal 106 such as beats per musical measure characteristics related to a time signature for the audio signal 106.

The dereverberation neural network model 110 may be configured to generate an audio dereverberation mask associated with the audio signal 106. In some examples, the audio feature set may be input to the RT estimation model 112. The RT estimation model 112 may be configured to generate reverberation time data associated with the audio signal 106. The reverberation time data may characterize the decay of sound reflections in an acoustic environment. For example, the reverberation time data may include, but is not limited to, estimates of reverberation time values that represent the time required for sound reflections to decrease by a certain degree (e.g., 60 decibels) after the sound source has stopped propagating through the environment.

In some examples, the reverberation time data may provide quantitative measures of reverberation characteristics that may be utilized to inform and/or optimize dereverberation processing, adapt filter parameters, and/or provide insights to users regarding acoustic properties of the environment. In some examples, the reverberation time data may be calculated for different frequency bands of the audio signal 106.

Modeling output data 111 provided by the dereverberation neural network model 110 and the RT estimation model 112 may include the audio dereverberation mask and the reverberation time data. For example, the modeling output data 111 may include one or more computed masks, filters, and/or other data provided by the dereverberation neural network model 110 and/or the RT estimation model 112. Based on the modeling output data 111 (e.g., the audio dereverberation mask and the reverberation time data), the dereverberation system 102 may generate the dereverberation audio signal 108. For example, the audio dereverberation mask and/or one or more filters associated with the reverberation time data may be applied to the audio signal 106 to generate the dereverberation audio signal 108.

The audio dereverberation mask may be a time-frequency representation that is applied to the audio signal to reduce or remove reverberation effects of the audio signal 106. The audio dereverberation mask may be real-valued or complex-valued. Additionally, the audio dereverberation mask may be adapted based on estimated reverberation characteristics of the environment. In some examples, the audio dereverberation mask may be a magnitude mask, a complex mask, a ratio mask, a filtered mask, or another type of mask.

In some examples, the audio dereverberation mask includes gain values for different time-frequency bins of a time-frequency representation (e.g., an audio spectrogram) for the audio signal 106. When applied to the audio signal 106, the audio dereverberation mask may modify a magnitude and/or phase of frequency components to suppress reverberant energy while preserving desired speech or audio content for the audio signal 106. Post-processing with further mask manipulations and/or other audio enhancements may also be applied to the audio signal 106 to generate the dereverberation audio signal 108.

The dereverberation neural network model 110 may be a deep neural network. For instance, the dereverberation neural network model 110 may be structured as a deep neural network comprising multiple layers designed to process audio features and generate an audio dereverberation mask. The dereverberation neural network model 110 may include one or more: convolutional layers to extract spatial and temporal features from the audio signal 106, recurrent layers such as Long Short-Term Memory (LSTM) or Gated Recurrent Units (GRU) to capture long-term dependencies in the audio signal 106, and/or other layers to enable deep neural network learning. The dereverberation neural network model 110 may include direct connections or residual connections between layers to enable gradient flow and/or learning of fine and coarse-grained features. An output layer of the dereverberation neural network model 110 may provide a time-frequency complex mask or filter representing a dereverberation prediction for the audio signal 106. The dereverberation neural network model 110 may also guide one or more other DSP processes to effectively reduce reverberation and/or to preserve desirable audio (e.g., speech) associated with the audio signal 106.

The dereverberation neural network model 110 may be trained based on a feature set associated with audio samples. In some examples, the dereverberation neural network model 110 is trained based on a feature set associated with numerous acoustic spaces. During training, the dereverberation neural network model 110 may also be optimized using a dataset of paired reverberant and clean audio samples. Training of the dereverberation neural network model 110 may be executed to tune parameters of the dereverberation neural network model 110 by minimizing the difference between the dereverberated output and the clean reference audio. A loss function may incorporate both time-domain and frequency-domain components to ensure high-quality dereverberation via the dereverberation neural network model 110.

The training may utilize training techniques such as curriculum learning or other training techniques where the dereverberation neural network model 110 is gradually exposed to increasingly complex reverberation scenarios to enhance performance of the dereverberation neural network model 110. Additionally, the dereverberation neural network model 110 may be fine-tuned to improve the quality of a dereverberated prediction for audio.

In some examples, the dereverberation neural network model 110 may inform a series of filters configured to reduce reverberation. The filters may be configured to maintain a natural tone of speech by reducing coloration caused by reverberation (e.g., not just a reverberation tail portion of the audio signal 106). In some examples, output of the dereverberation neural network model 110 may be utilized for a magnitude mask to provide more effective mitigation of reverberation.

To enable the dereverberation for the audio signal 106, the RT estimation model 112 may utilize real-time RT60 measurements associated with an audio environment to estimate reverberation characteristics of the audio environment. As such, by utilizing output provided by the RT estimation model 112, the dereverberation system 102 may apply an optimal amount of reverberation reduction to the audio signal 106 while preserving other audio characteristics of the audio signal 106 such as, for example, speech clarity.

In some examples, the audio signal processing system 100 additionally includes a user control system 104. The user control system 104 may enable user control with respect to the audio dereverberation mask and/or other dereverberation filtering associated with the audio signal 106. The dereverberation system 102 may receive user dereverberation control parameters from the user control system 104. In some examples, the user control system 104 is associated with a user device. Accordingly, in some examples, the dereverberation system 102 may receive the user dereverberation control parameters via an electronic interface of a user device. The electronic interface may also be configured to display visual data associated with the reverberation time data. For example, the electronic interface may render an RT60 display based on output of the RT estimation model 112.

In some examples, the dereverberation system 102 may apply the user dereverberation control parameters to the audio dereverberation mask to generate a user-modified dereverberation mask. A user may control dereverberation associated with the audio signal 106 by determining priority of a goal of the dereverberation. For example, a goal may be to prioritize speech quality, balance, or prioritize removing dereverberation associated with the audio signal 106. User priorities may also be mapped to a degree of the dereverberation by measuring or approximating the reverberation qualities of the audio environment based on the reverberation time data generated by the RT estimation model 112. The reverberation time data may also be based on an RT60 signal associated with the audio environment. As such, the dereverberation audio signal 108 may be based on the audio dereverberation mask, the reverberation time data, and/or the user-modified dereverberation mask.

In some examples, the dereverberation system 102 may apply post-processing to the audio dereverberation mask to provide further audio processing related to the audio dereverberation mask. To enable additional audio processing, the dereverberation system 102 may input the dereverberation audio signal to an automixer configured to optimize audio associated with the audio environment.

In some examples, the audio dereverberation mask is a first audio dereverberation mask and the dereverberation neural network model 110 includes two or more dereverberation neural network models. As such, the audio feature set may be input to a first dereverberation neural network model configured to generate a first audio dereverberation mask associated with the audio signal 106. The audio feature set may also be input to at least a second dereverberation neural network model configured to generate a second audio dereverberation mask associated with the audio signal 106. Accordingly, the dereverberation system 102 may generate the dereverberation audio signal 108 based on at least the first audio dereverberation mask, the second audio dereverberation mask, and the reverberation time data.

In some examples, the audio feature set and the audio dereverberation mask is input to a post-filtering model configured to generate an equivalent complex mask associated with the audio signal 106. Additionally, the dereverberation audio signal may be generated based on the audio dereverberation mask, the reverberation time data, and the equivalent complex mask.

The post-filtering model may be structured as a neural network architecture configured to generate an equivalent complex mask for enhanced audio processing. The input for the post-filtering model may include the audio feature set and the audio dereverberation mask produced by the dereverberation neural network model 110. The post-filtering model may comprise multiple layers of convolutional and recurrent units. In some examples, dilated convolutions of the post-filtering model may capture long-range dependencies in the audio signal 106. The post-filtering model may also include attention mechanisms to focus on relevant time-frequency regions of the input. An output layer of post-filtering model may provide complex-valued coefficients to enable both magnitude and phase modifications of the input audio.

During training, the post-filtering model may be optimized using a dataset of diverse audio samples. The training may optimize parameters of the post-filtering model by minimizing a complex-valued loss function that considers both the magnitude and phase differences between processed and target audio. In some examples, the training of the post-filtering model may utilize training techniques such as complex backpropagation and gradient clipping to handle the challenges of complex-valued optimization. The post-filtering model may also be trained end-to-end with the dereverberation neural network model 110 to enable learning of complementary filtering operations that further enhance the dereverberation process. In some examples, the post-filtering model may be trained to process complex valued features. The joint training approach between the post-filtering model and the dereverberation neural network model 110 may enable the post-filtering model to refine and extend the dereverberation capabilities of the overall system. In some examples, the post-filtering model may enable improved dereverberation by accounting for subtle acoustic artifacts or residual reverberation not fully captured by the initial dereverberation mask.

In some examples, the audio dereverberation mask may be input to a discriminator classification model to generate a reverberation prediction associated with the audio signal. Additionally, the dereverberation neural network model 110 may be retrained based on the reverberation prediction.

The discriminator classification model may be a convolutional neural network configured to distinguish between dereverberated and reverberant audio signals. The input of the discriminator classification model may include output of the dereverberation neural network model 110 (e.g., the audio dereverberation mask) and ground truth data (e.g., ground truth reference dry speech). Additionally, the discriminator classification model may provide a reverberation prediction (e.g., a classified likelihood of a level of reverberance given the input) as output. The machine learning architecture of the discriminator classification model may include multiple convolutional layers with increasing filter sizes to capture both local and global patterns in the mask. The convolutional layers may be followed by pooling layers to reduce dimensionality and fully connected layers for the final classification. In some examples, the discriminator classification model may incorporate batch normalization and dropout layers to improve training stability and prevent overfitting.

During training, the discriminator classification model may be optimized using a dataset of labeled audio samples. The dataset of labeled audio samples may include successfully dereverberated audio and audio with varying degrees of reverberation. The training objective for the discriminator classification model may be to maximize the ability of the discriminator classification model to correctly classify the level of reverberation present in the audio signal 106. In some examples, training of the discriminator classification model may utilize a binary cross-entropy loss function for reverberant/non-reverberant classification, a multi-class loss function for more fine-grained reverberation level prediction, or other types of loss function for optimizing the discriminator classification model. A prediction provided by the discriminator classification model may then be utilized to provide feedback for retraining or fine-tuning the dereverberation neural network model 110. In some examples, a prediction provided by the discriminator classification model may be utilized to generate an adversarial training setup that may improve overall dereverberation performance of the dereverberation system 102.

The audio signal processing system 100 and/or one or more other aspects disclosed herein provides improved dereverberation as compared to traditional audio processing algorithms. For example, the audio signal processing system 100 and/or one or more other aspects disclosed herein may transform an audio experience for a listener by mitigating or removing reverberation associated with an audio environment. In some examples, the audio signal processing system 100 and/or one or more other aspects disclosed herein may intelligently detect and preserves speech in the audio signal 106 while minimizing reverb.

In some examples, the audio signal processing system 100 and/or one or more other aspects disclosed herein may improve performance by calculating a real-time RT60 value (e.g., time for reverb to decay by 60 dB) for an audio environment and/or utilizing to RT60 value adjust intensity, bandwidth, and/or a spectrogram mask associated with the audio signal 106. The audio signal processing system 100 and/or one or more other aspects disclosed herein may provide sophisticated audio balancing to allow audio to retain a natural quality while also eliminating reverb tails, echoes, and/or coloration.

It is to be appreciated that, the audio signal processing system 100 and/or one or more other aspects disclosed herein may employ fewer of computing resources when compared to traditional audio processing systems that are used for digital signal processing. In some examples, the audio signal processing system 100 and/or one or more other aspects disclosed herein may be configured to deploy a smaller number of memory resources allocated to dereverberation, denoising, and/or other audio filtering for an audio signal sample such as, for example, the audio signal 106. In still other examples, the audio signal processing system 100 and/or one or more other aspects disclosed herein may be configured to improve processing speed of dereverberation operations, denoising operations, and/or audio filtering operations.

The audio signal processing system 100 and/or one or more other aspects disclosed herein may also be configured to reduce a number of computational resources associated with applying machine learning models such as, for example, the dereverberation neural network model 110 and/or the RT estimation model 112, to the task of dereverberation, denoising, and/or other audio filtering. These improvements enable, in some examples, for an improved audio processing systems to be deployed in microphones or other hardware/software configurations where processing and memory resources are limited, and/or where processing speed and efficiency is important.

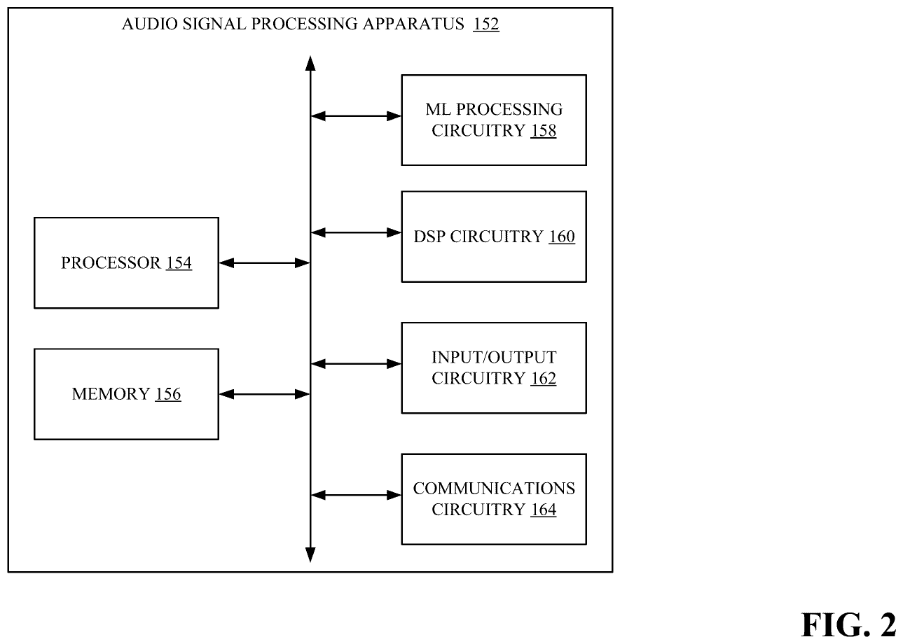

FIG. 2 illustrates an example audio signal processing apparatus 152 configured in accordance with one or more embodiments of the present disclosure. The audio signal processing apparatus 152 may be configured to perform one or more techniques described in FIG. 1 and/or one or more other techniques described herein. In one or more embodiments, the audio signal processing apparatus 152 may be embedded in the dereverberation system 102.

In some cases, the audio signal processing apparatus 152 may be a computing system communicatively coupled with, and configured to control, one or more circuit modules associated with audio processing. For example, the audio signal processing apparatus 152 may be a computing system and/or a computing system communicatively coupled with one or more circuit modules related to audio processing. The audio signal processing apparatus 152 may comprise or otherwise be in communication with a processor 154, a memory 156, ML processing circuitry 158, DSP circuitry 160, input/output circuitry 162, and/or communications circuitry 164. In some examples, the processor 154 (which may comprise multiple or co-processors or any other processing circuitry associated with the processor) may be in communication with the memory 156.

The memory 156 may comprise non-transitory memory circuitry and may comprise one or more volatile and/or non-volatile memories. In some examples, the memory 156 may be an electronic storage device (e.g., a computer readable storage medium) configured to store data that may be retrievable by the processor 154. In some examples, the data stored in the memory 156 may comprise radio frequency signal data, audio data, stereo audio signal data, mono audio signal data, or the like, for enabling the apparatus to carry out various functions or methods in accordance with embodiments of the present disclosure, described herein.

In some examples, the processor 154 may be embodied in a number of different ways. For example, the processor 154 may be embodied as one or more of various hardware processing means such as a central processing unit (CPU), a microprocessor, a coprocessor, a DSP, an Advanced RISC Machine (ARM), a field programmable gate array (FPGA), a neural processing unit (NPU), a graphics processing unit (GPU), a system on chip (SoC), a cloud server processing element, a controller, or a processing element with or without an accompanying DSP. The processor 154 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some examples, the processor 154 may comprise one or more processing cores configured to perform independently. A multi-core processor may enable multiprocessing within a single physical package. The processor 154 may comprise one or more processors configured in tandem via the bus to enable independent execution of instructions, pipelining, and/or multithreading.

In some examples, the processor 154 may be configured to execute instructions, such as computer program code or instructions, stored in the memory 156 or otherwise accessible to the processor 154. Alternatively or additionally, the processor 154 may be configured to execute hard-coded functionality. As such, whether configured by hardware or software instructions, or by a combination thereof, the processor 154 may represent a computing entity (e.g., physically embodied in circuitry) configured to perform operations according to an embodiment of the present disclosure described herein. For example, when the processor 154 is embodied as an CPU, DSP, ARM, FPGA, ASIC, or similar, the processor may be configured as hardware for conducting the operations of an embodiment of the disclosure described herein. Alternatively, when the processor 154 is embodied to execute software or computer program instructions, the instructions may specifically configure the processor 154 to perform the algorithms and/or operations described herein when the instructions are executed. However, in some cases, the processor 154 may be a processor of a device specifically configured to employ an embodiment of the present disclosure by further configuration of the processor using instructions for performing the algorithms and/or operations described herein. The processor 154 may further comprise a clock, an arithmetic logic unit (ALU) and logic gates configured to support operation of the processor 154, among other things.

In some examples, the audio signal processing apparatus 152 may comprise the ML processing circuitry 158. The ML processing circuitry 158 may be any means embodied in either hardware or a combination of hardware and software that is configured to perform one or more functions disclosed herein related to machine learning. In some examples, the ML processing circuitry 158 may perform one or more functions associated with the dereverberation neural network model 110, the RT estimation model 112, and/or one or more other neural network models disclosed herein related to machine learning. In some examples, the audio signal processing apparatus 152 may comprise the DSP circuitry 160. The DSP circuitry 160 may be any means embodied in either hardware or a combination of hardware and software that is configured to perform one or more functions disclosed herein related to digital signal processing. In some examples, the DSP circuitry 160 may perform one or more operations associated with applying computed masks and/or filters to the audio signal 106 to generate the dereverberation audio signal 108.

In some examples, the audio signal processing apparatus 152 may comprise the input/output circuitry 162 that may, in turn, be in communication with processor 154 to provide output to the user and, in some examples, to receive an indication of a user input. The input/output circuitry 162 may comprise a user interface and may comprise a display. In some examples, the input/output circuitry 162 may also comprise a keyboard, a touch screen, touch areas, soft keys, buttons, knobs, or other input/output mechanisms.

In some examples, the audio signal processing apparatus 152 may comprise the communications circuitry 164. The communications circuitry 164 may be any means embodied in either hardware or a combination of hardware and software that is configured to receive and/or transmit data from/to a network and/or any other device or module in communication with the audio signal processing apparatus 152. In this regard, the communications circuitry 164 may comprise, for example, an antennae or one or more other communication devices for enabling communications with a wired or wireless communication network. For example, the communications circuitry 164 may comprise antennae, one or more network interface cards, buses, switches, routers, modems, and supporting hardware and/or software, or any other device suitable for enabling communications via a network. The communications circuitry 164 may comprise the circuitry for interacting with the antenna/antennae to cause transmission of signals via the antenna/antennae or to handle receipt of signals received via the antenna/antennae.

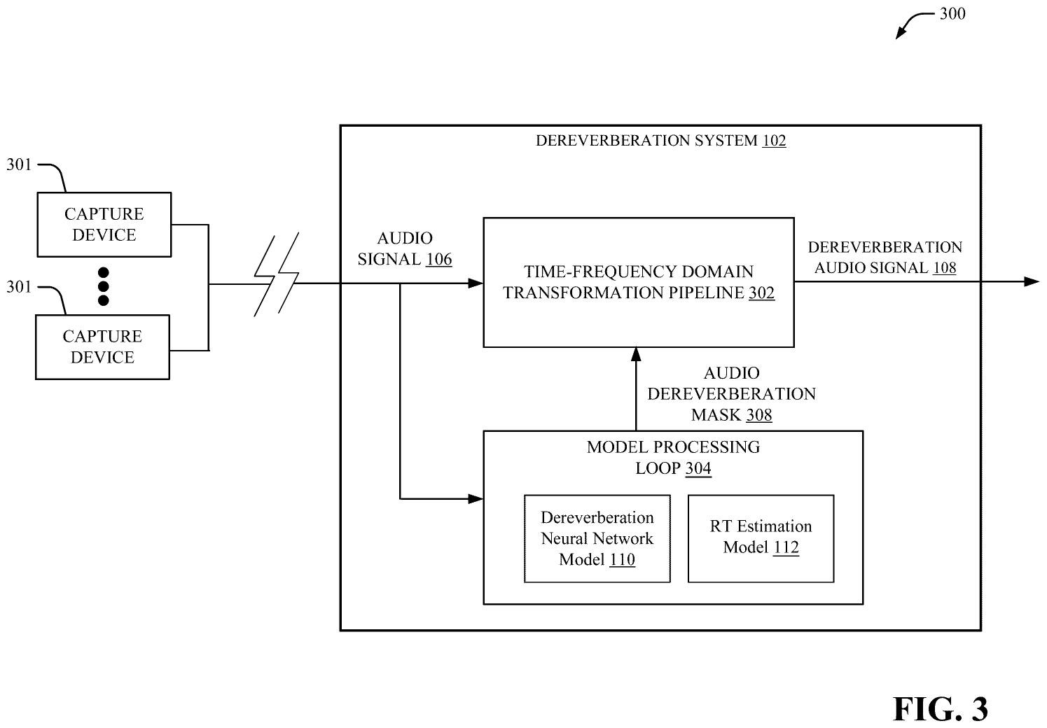

FIG. 3 illustrates an audio signal processing system 300 that is configured to provide dereverberation associated with an audio signal, according to embodiments of the present disclosure. The audio signal processing system 300 may be a subsystem and/or an example embodiment of the audio signal processing system 100. The audio signal processing system 300 includes the dereverberation system 102. As illustrated in FIG. 3, the dereverberation system 102 includes a time-frequency domain transformation pipeline 302 and a model processing loop 304. The model processing loop 304 includes the dereverberation neural network model 110 and/or the RT estimation model 112. In some examples, the model processing loop 304 is a neural network processing loop.

The dereverberation system 102 may receive the audio signal 106. In some examples, the audio signal 106 is generated by one or more capture devices 301 located within an audio environment. In some examples, audio signal 106 generated by the one or more capture devices 301 may be converted into one or more audio signal samples. The one or more audio signal samples associated with the audio signal 106 may be provided to the time-frequency domain transformation pipeline 302 for a transformation period. The time-frequency domain transformation pipeline 302 may form part of a digital signal processing process. Additionally, the one or more audio signal samples may be provided to the model processing loop 304. In some examples, the dereverberation neural network model 110 of the model processing loop 304 may be configured to generate an audio dereverberation mask 308 associated with the audio signal 106.

The audio dereverberation mask 308 may be a time-frequency representation that is applied to the audio signal to reduce or remove reverberation effects of the audio signal 106. The audio dereverberation mask 308 may be real-valued or complex-valued. Additionally, the audio dereverberation mask 308 may be adapted based on estimated reverberation characteristics of the environment. In some examples, the audio dereverberation mask 308 may be a magnitude mask, a complex mask, a ratio mask, a filtered mask, or another type of mask. In some examples, the audio dereverberation mask 308 includes gain values for different time-frequency bins of a time-frequency representation (e.g., an audio spectrogram) for the audio signal 106.

To enable machine learning via the dereverberation neural network model 110 and/or the RT estimation model 112, the one or more audio signal samples may be converted into a non-uniform-bandwidth frequency domain representation. Additionally, the non-uniform-bandwidth frequency domain representation of the one or more audio signal samples may be input to the dereverberation neural network model 110 and/or the RT estimation model 112. In some examples, the non-uniform-bandwidth frequency domain representation includes a Bark scale format, an Equivalent Rectangular Bandwidth (ERB) format, a wavelet filter banks format, an MFCC format, or another type of format.

In a circumstance where the audio dereverberation mask 308 is determined prior to expiration of the transformation period (e.g., prior to a real-time constraint for the transformation period), the audio dereverberation mask 308 may be applied to a frequency domain version of the one or more audio signal samples associated with the time-frequency domain transformation pipeline 302 to generate the dereverberation audio signal 108. For instance, based on the audio dereverberation mask 308 being determined prior to an expiration of the transformation period, a neural network dereverberated version of the audio signal 106 may be output via the time-frequency domain transformation pipeline 302.

However, in a circumstance where the audio dereverberation mask 308 is not determined prior to expiration of the transformation period, a default version of the audio signal 106 may be output via the time-frequency domain transformation pipeline 302 without applying the audio dereverberation mask 308 to the audio signal 106. The default version of the audio signal 106 may be based on a default dereverberation mask associated with a default dereverberation prediction for the time-frequency domain transformation pipeline 302, a prior dereverberation mask associated with a prior dereverberation prediction provided by the model processing loop 304, a passthrough mask for the time-frequency domain transformation pipeline 302 that is configured without dereverberation, or default digital signal processing associated with the time-frequency domain transformation pipeline 302.

As such, the dereverberation system 102 may utilize failsafe functionality to allow disablement of the dereverberation associated with the dereverberation neural network model 110 if a required processing time associated with the model processing loop 304 is not satisfied for digital signal processing real-time constraints associated with the time-frequency domain transformation pipeline 302. The failsafe functionality may also enable a low latency implementation of the digital signal processing path for the audio signal 106 with computation robustness such that the dereverberation is not applied to the audio signal 106 in an event of misses in the computational timing and/or certain processing errors with respect to the dereverberation audio processing via the model processing loop 304.

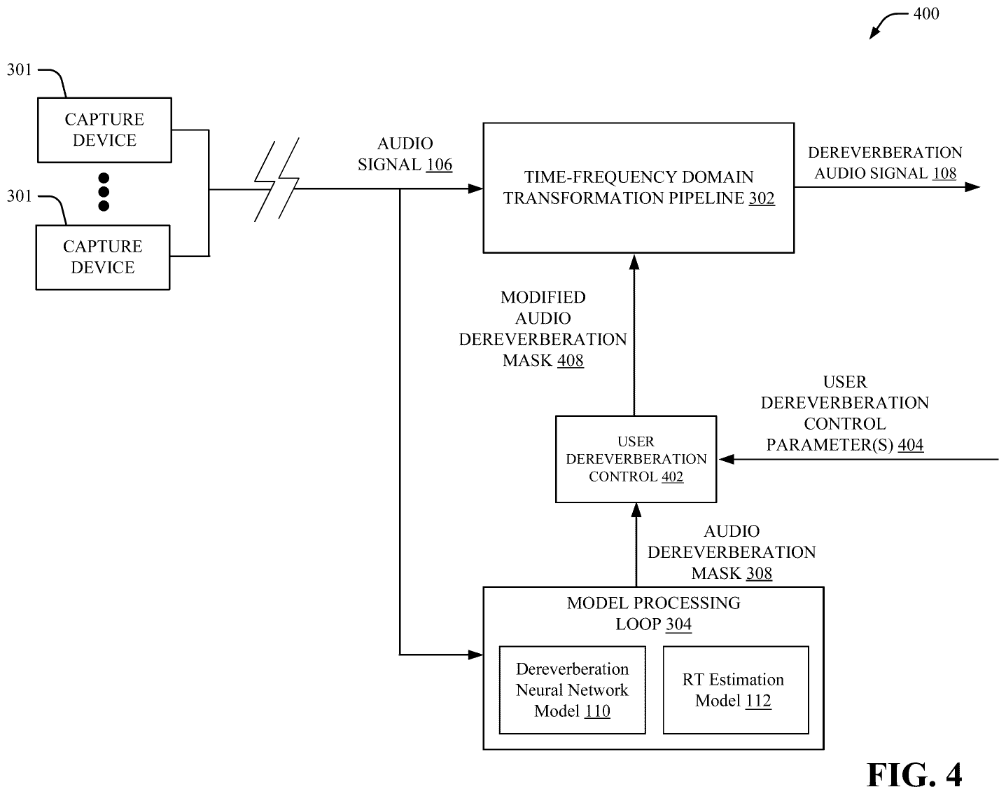

FIG. 4 illustrates an audio signal processing system 400 that is configured to provide dereverberation associated with an audio signal, according to embodiments of the present disclosure. The audio signal processing system 400 may be a subsystem and/or an example embodiment of the audio signal processing system 100 and/or the audio signal processing system 300. The audio signal processing system 400 includes the dereverberation system 102. As illustrated in FIG. 4, the dereverberation system 102 includes the time-frequency domain transformation pipeline 302, the model processing loop 304, and user dereverberation control 402. In some examples, the model processing loop 304 includes the dereverberation neural network model 110 and/or the RT estimation model 112.

To enable processing of the audio dereverberation mask 308 based on user input, the user dereverberation control 402 may apply a dereverberation user level to the audio dereverberation mask 308 to generate a modified audio dereverberation mask 408. For example, the user dereverberation control 402 may receive one or more user dereverberation control parameters 404. The one or more user dereverberation control parameters 404 may be generated by a user device in response to user engagement with an audio processing control user interface. For example, the one or more user dereverberation control parameters 404 may be generated via a user engagement dereverberation interface associated with an audio processing control user interface. Furthermore, the user dereverberation control 402 may apply the one or more user dereverberation control parameters 404 to the audio dereverberation mask 308 to generate the modified audio dereverberation mask 408. As such, in an example, the modified audio dereverberation mask 408 may be a user-modified dereverberation mask.

In an example, the one or more user dereverberation control parameters 404 may be configured with an off value, a low dereverberation value, a medium dereverberation value, a high dereverberation value, or another type of value. Furthermore, the user dereverberation control 402 may be configured to modify the audio dereverberation mask 308 (e.g., to generate the modified audio dereverberation mask 408) based on the one or more user dereverberation control parameters 404 configured with an off value, a low dereverberation value, a medium dereverberation value, a high dereverberation value, or another type of value.

The user dereverberation control 402 may also receive user RT60 input 405. The user RT60 input 405 may be generated by a user device in response to user engagement with an audio processing control user interface. For example, the user RT60 input 405 may be generated via a user engagement dereverberation interface associated with an audio processing control user interface. In some examples, the user RT60 input 405 may be a user defined RT60 value or a user selected RT60 value for an audio environment. Furthermore, the user dereverberation control 402 may apply the user RT60 input 405 to the audio dereverberation mask 308 to generate the modified audio dereverberation mask 408.

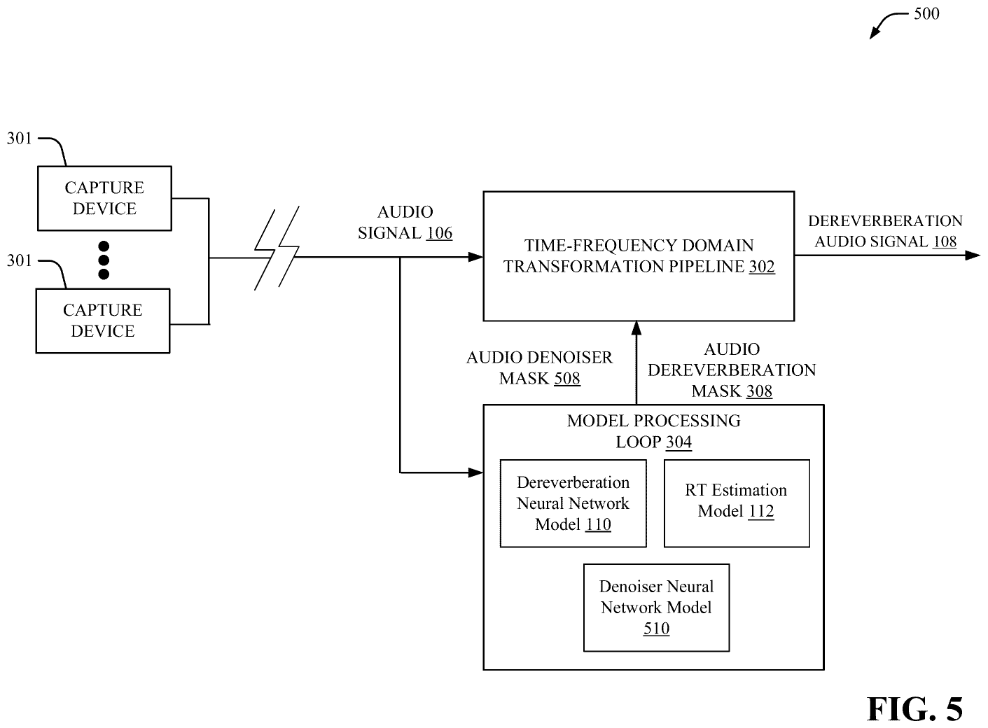

FIG. 5 illustrates an audio signal processing system 500 that is configured to provide dereverberation associated with an audio signal, according to embodiments of the present disclosure. The audio signal processing system 500 may be a subsystem and/or an example embodiment of the audio signal processing system 100, the audio signal processing system 300, and/or the audio signal processing system 400. The audio signal processing system 500 includes the dereverberation system 102. As illustrated in FIG. 5, the dereverberation system 102 includes the time-frequency domain transformation pipeline 302 and the model processing loop 304. However, it is to be appreciated that, in some examples, the dereverberation system 102 additionally includes the user dereverberation control 402. In some examples, the model processing loop 304 includes the dereverberation neural network model 110, the RT estimation model 112, and/or a denoiser neural network model 510.

The dereverberation system 102 may receive the audio signal 106. In some examples, the audio signal 106 is generated by the one or more capture devices 301 located within an audio environment. In some examples, audio signal 106 generated by the one or more capture devices 301 may be converted into one or more audio signal samples. The one or more audio signal samples associated with the audio signal 106 may be provided to the time-frequency domain transformation pipeline 302 for a transformation period. The time-frequency domain transformation pipeline 302 may form part of a digital signal processing process. Additionally, the one or more audio signal samples may be provided to the model processing loop 304. The dereverberation neural network model 110 of the model processing loop 304 may be configured to generate the audio dereverberation mask 308 associated with the audio signal 106. Additionally, the denoiser neural network model 510 may be configured to generate an audio denoiser mask 508 associated with the audio signal 106.

In some examples, the one or more audio signal samples are converted into a non-uniform-bandwidth frequency domain representation. Additionally, the non-uniform-bandwidth frequency domain representation of the one or more audio signal samples may be input to the dereverberation neural network model 110, the RT estimation model 112, and/or the denoiser neural network model 510. In some examples, the non-uniform-bandwidth frequency domain representation includes a Bark scale format, an ERB format, a wavelet filter banks format, an MFCC format, or another type of format.

In a circumstance where the audio dereverberation mask 308 and/or the audio denoiser mask 508 is determined prior to expiration of the transformation period, the audio dereverberation mask 308 and/or the audio denoiser mask 508 may be applied to a frequency domain version of the one or more audio signal samples associated with the time-frequency domain transformation pipeline 302 to generate the dereverberation audio signal 108. In some examples, based on the audio dereverberation mask 308 and the audio denoiser mask 508 being applied to the frequency domain version of the one or more audio signal samples, the dereverberation audio signal 108 may be a dereverberated and denoised version of the audio signal 106.

An example denoiser neural network model 510 is discussed in detail in connection with the audio processing systems disclosed in commonly owned U.S. patent application Ser. No. 17/679,904, titled “DEEP NEURAL NETWORK DENOISER MASK GENERATION SYSTEM FOR AUDIO PROCESSING,” and filed on Feb. 24, 2022, which is hereby incorporated by reference in its entirety.

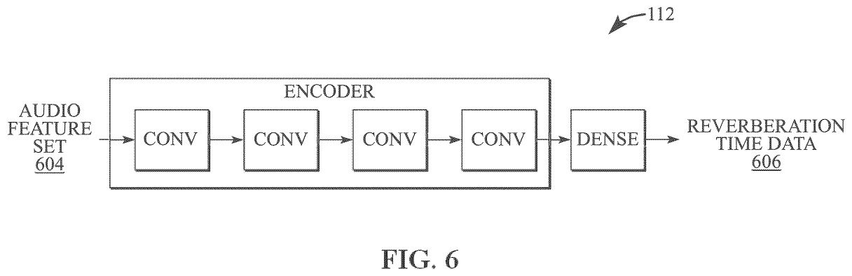

FIG. 6 illustrates an example RT estimation model 112, according to embodiments of the present disclosure. The RT estimation model 112 may receive an audio feature set 604 as input. The audio feature set 604 may include one or more audio features for the audio signal 106. The audio feature set 604 may also represent physical features and/or perceptual features related to the audio signal 106. For instance, the one or more audio features may comprise: one or more: audio spectrum features, magnitude features, phase features, pitch features, harmonic features, MFCC features, performance features, performance sequencer features, tempo features, time signature features, and/or other types of features associated with the audio signal 106.

The RT estimation model 112 may be structured as an encoder architecture comprising a series of convolutional layers followed by a dense layer. As illustrated in FIG. 6, the model may include a set of sequential convolutional layers that respectively process and extract increasingly tuned features from the audio feature set 604. The final convolutional layer output may then feed into a dense layer that produces the reverberation time data 606. The encoder architecture may enable the RT estimation model 112 to learn time hierarchical representations of input audio such as the audio signal 106. Machine learning via the RT estimation model 112 may capture both local and global patterns relevant to reverberation time estimation.

The RT estimation model 112 may be trained on a diverse dataset of audio samples with known reverberation time values that encompass various acoustic environments and/or reverberation conditions. During training, the RT estimation model 112 may learn to map input audio features to accurate reverberation time estimates by minimizing a loss function that measures a difference between predicted and ground truth reverberation values. The training process may involve techniques such as batch normalization, dropout, or regularization to improve adaptability of the RT estimation model 112 and prevent overfitting. Once trained, the RT estimation model 112 may process new audio inputs in real-time, to provide reverberation time estimates that may be utilized to inform and optimize a dereverberation process for an audio signal such as the audio signal 106.

During inference phase, the RT estimation model 112 may be applied to the audio feature set 604 to generate reverberation time data 606. In some examples, the reverberation time data 606 includes an RT60 estimation. The RT estimation model 112 includes an encoder associated with a set of convolutional layers that processes the audio feature set 604. Additionally, the RT estimation model 112 may include a dense layer that receives output data from the respective convolutional layers of the RT estimation model 112 to generate the reverberation time data 606. For example, the dense layer may provide the RT estimation based on output data provided by the respective convolutional layers of the RT estimation model 112.

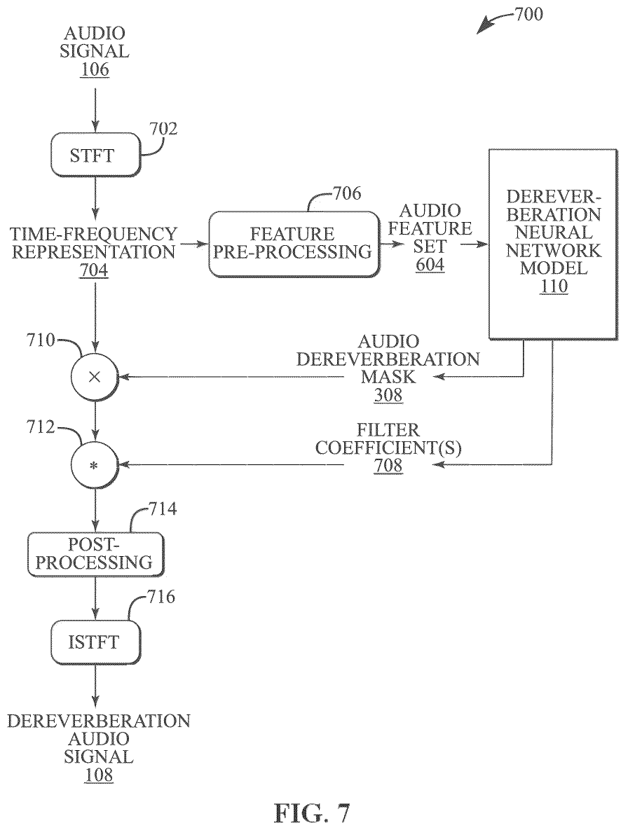

FIG. 7 illustrates an example dereverberation data flow 700, according to embodiments of the present disclosure. The dereverberation data flow 700 may correspond to a dereverberation machine learning pipeline (e.g., a dereverberation DNN pipeline) for processing the audio signal 106 via the dereverberation neural network model 110. In some examples, the audio signal may comprise reverberant/noisy speech waveform input that is processed via the dereverberation data flow 700 to provide an enhanced speech waveform.

The audio signal 106 may be transformed into a time-frequency representation 704 of the audio signal 106 by applying a Short-Time Fourier Transform (STFT) 702 to the audio signal 106. The time-frequency representation 704 may comprise a spectrogram representation or another type of time-frequency representation for the audio signal 106. The resulting time-frequency representation 704 may then undergo feature pre-processing 706 to generate the audio feature set 604 for the dereverberation neural network model 110. In some examples, the feature pre-processing 706 may include normalization, transformation, and/or augmentation of the time-frequency representation 704. The audio feature set 604 may be provided as input to the dereverberation neural network model 110.

The dereverberation neural network model 110 may be configured to generate the audio dereverberation mask 308 based on the audio feature set 604. The audio dereverberation mask 308 may be applied to the time-frequency representation 704 via an audio processing operation 710. The audio processing operation 710 may comprise a multiplication operation between the time-frequency representation 704 and the audio dereverberation mask 308. For instance, the audio processing operation 710 may modify a magnitude of the time-frequency representation 704 on a per-frequency and/or per-timeframe basis based on the audio dereverberation mask 308.

In some examples, the audio dereverberation mask 308 comprises a set of real-valued dereverberation masks that is multiplied onto the time-frequency representation 704 via the audio processing operation 710 to achieve dereverberation by modifying per-band of the time-frequency representation 704 and/or per-timeframe gain of the time-frequency representation 704. As such, by applying the audio dereverberation mask 308 to the time-frequency representation 704, certain frequency components of the audio signal 106 may be selectively attenuated and/or amplified.

Additionally, the dereverberation neural network model 110 may be configured to generate filter coefficient(s) 708 to enable filtering of the time-frequency representation 704 via convolution. For instance, the filter coefficient(s) 708 may comprise a set of complex valued finite impulse response (FIR) filter coefficients, a set of infinite impulse response (IIR) filter coefficients, a set of 1D or 2D convolutional kernels, or another type of filter coefficient to filter the time-frequency representation 704 via convolution. In some examples, a convolution operation 712 may utilize the filter coefficient(s) 708 to modify gain and phase for the time-frequency representation 704, thereby enabling more natural sounding audio output for the audio signal 106.

In some examples, post-processing 714 may be performed to provide the user dereverberation control 402, failsafe protection, and/or other enhancement for the time-frequency representation 704 associated with the audio signal 106. Additionally, the masked and/or post-processed version of the time-frequency representation 704 may be transformed into a time-domain waveform via an Inverse Short-Time Fourier Transform (ISTFT) 716 to provide the dereverberation audio signal 108. For instance, the dereverberation audio signal 108 may be an enhanced version of the audio signal 106 that is configured as an enhanced speech waveform or another type of enhanced audio signal.

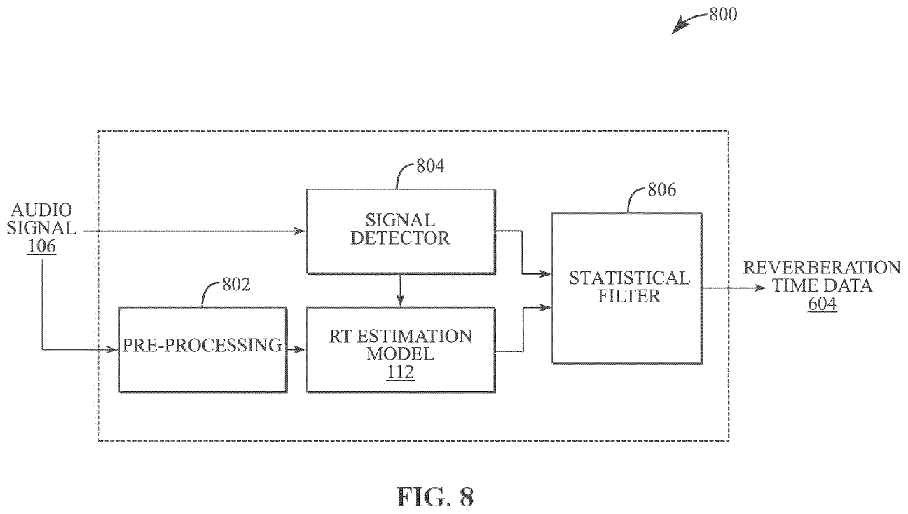

FIG. 8 illustrates an example system 800 associated with reverberation time estimation, according to embodiments of the present disclosure. The system 800 may utilize machine learning and/or artificial intelligence to enable a reverberation time estimation for the audio signal 106. For example, the system 800 may provide the reverberation time data 606 by utilizing the RT estimation model 112. The system 800 may also be executed in real time as compared to execution of the dereverberation neural network model 110.

With the system 800, the audio signal 106 may undergo pre-processing 802 to generate an audio feature set (e.g., the audio feature set 604) for audio signal 106. In some examples, the pre-processing 802 may correspond to the feature pre-processing 706. The audio feature set provided by the pre-processing 802 may comprise ERB features, Mel coefficient features, STFT features, time domain audio features, and/or another type of features for the audio signal 106. The audio feature set may then be provided as input to the RT estimation model 112. The RT estimation model 112 may be configured to generate the reverberation time data 606 based on the audio feature set provided by the pre-processing 802.

In some examples, execution of the RT estimation model 112 may be initiated based on detection of the audio signal 106 via a signal detector 804. For instance, the signal detector 804 may condition the RT estimation model 112 to execute in response to detection of a signal such as the audio signal 106. The signal detector 804 may trigger execution of the RT estimation model 112 based on one or more conditions associated with the audio signal 106 being satisfied. The one or more conditions associated with the audio signal 106 may comprise a quality condition, an active speech condition, or another type of condition for the audio signal 106 that enables efficient utilization of system resources and/or optimal execution of the RT estimation model 112.

In some examples, the signal detector 804 may analyze a pre-determined length of audio (e.g., 2.5 seconds). Additionally, in response to a determination that at least a certain percentage (e.g., 50%) of the audio contains meaningful audio (e.g., speech or other desirable audio as opposed to silence or background noise), the signal detector 804 may trigger execution of the RT estimation model 112. However, in response to a determination that the audio contains less than the certain percentage (e.g., less than 50%) of meaningful audio, the signal detector 804 may withhold execution of the RT estimation model 112. In some examples, the signal detector 804 may determine presence of a signal separately in the first and second halves of the audio signal 106 being analyzed such that execution of the RT estimation model 112 is triggered when a certain amount of signal presence is detected in the first half of the audio chunk. As such, dynamic execution of the RT estimation model 112 via the signal detector 804 may enable improved accuracy of output provided by the RT estimation model 112 as compared to executing the RT estimation model 112 without utilization of the signal detector 804.

To optimize output of the reverberation time data 606, a statistical filter 806 may be utilized by the system 800. For example, the statistical filter 806 may comprise a median filter or other static filter to remove outlier output and/or maintain consistent reverberation time output over time as compared to previous reverberation time predictions. Output of the RT estimation model 112 may be temporarily stored in a buffer that also stores one or more previous reverberation time predictions. Additionally, the statistical filter 806 may be applied to the buffer to provide the reverberation time data 606. In some examples, the RT estimation model 112 may provide a Direct-to-Reverberant Ratio (DRR) estimation, a Speech-to-Reverberation Modulation Energy ratio (SRMR), or another type of control signal to enable a reverberation time prediction.

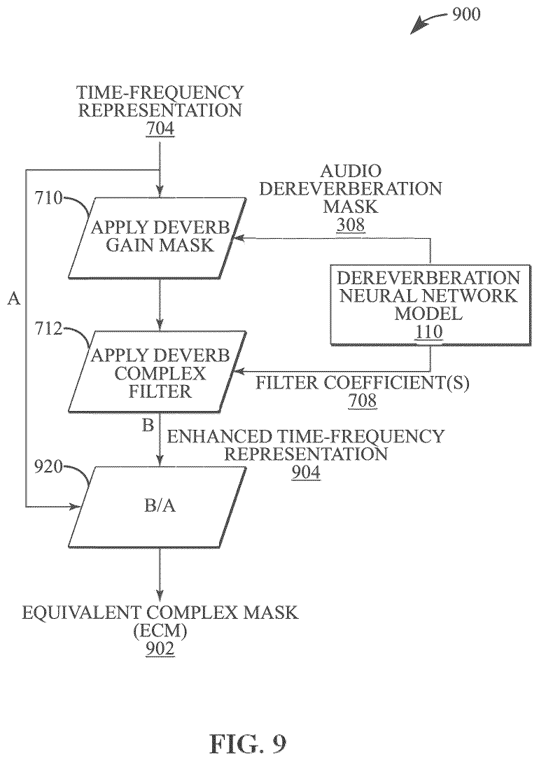

FIG. 9 illustrates an example mask calculation data flow 900, according to embodiments of the present disclosure. For example, the mask calculation data flow 900 may provide an equivalent complex mask 902 for the time-frequency representation 704 associated with the audio signal 106. Additionally, the mask calculation data flow 900 may enable optimized post-processing via the post-processing 714.

With the mask calculation data flow 900, the audio dereverberation mask 308 may be applied to the time-frequency representation 704 via the audio processing operation 710. For example, the audio dereverberation mask 308 may be a dereverberation gain mask that is applied to the time-frequency representation 704. Additionally, the filter coefficient(s) 708 may be applied to the time-frequency representation 704 via the convolution operation 712. For example, a dereverberation complex filter may be utilized to apply the filter coefficient(s) 708 to the time-frequency representation 704.

Based on the audio processing operation 710 and/or the convolution operation 712, an enhanced time-frequency representation 904 for the time-frequency representation 704 may be provided. Additionally, the mask calculation data flow 900 may include an audio processing operation 920 that generates the equivalent complex mask 902 based on the enhanced time-frequency representation 904 and the time-frequency representation 704. For example, the audio processing operation 920 may divide the enhanced time-frequency representation 904 by the time-frequency representation 704 to provide the equivalent complex mask 902. The equivalent complex mask 902 may be utilized to enable effective dereverberation level control and/or post processing for the time-frequency representation 704 of the audio signal 106 via the post-processing 714.

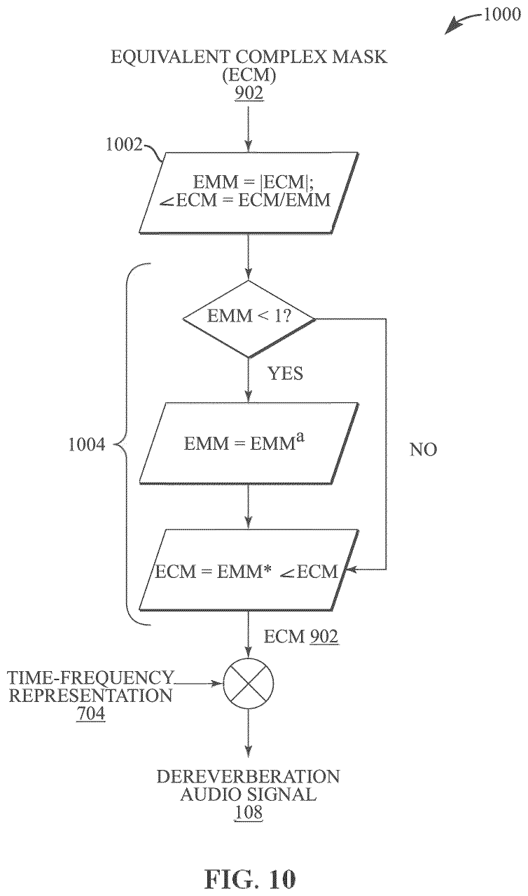

FIG. 10 illustrates an example mask exponentiation data flow 1000, according to embodiments of the present disclosure. The mask exponentiation data flow 1000 may utilize the equivalent complex mask 902 to provide an equivalent magnitude mask for the audio signal 106. Additionally, the equivalent magnitude mask may be utilized and/or modified with digital signal processing to control, mitigate, and/or limit the amount of dereverberation for the audio signal 106.

With the mask exponentiation data flow 1000, an audio processing operation 1002 is performed to generate an equivalent magnitude mask based on the equivalent complex mask 902. Additionally, the equivalent complex mask 902 may be enhanced based on the equivalent magnitude mask via an audio processing operation 1004. For example, mask exponentiation may be applied to equivalent magnitude masks values between 0 and 1 in order to provide additional dereverberation if the exponential value is greater than 1 and provide less dereverberation if the exponential value is less than 1. Using the example of an exponential of 2, the exponential operation has a relationship such that numbers closer to 1 when squared are not greatly affected (e.g., 0.99*0.99=0.981) whereas numbers that are closer to 0 may be more affected (e.g., 0.01*0.01=0.0001).

As such, an equivalent magnitude mask approximately equal to or greater than 1 may correspond to desirable audio (e.g., desired speech), and an equivalent magnitude mask approximately equal to zero or equal to zero may correspond to undesired reverberation audio. In some examples, the mask exponentiation via the audio processing operation 1004 may enable a greater separation between a desired and an undesired audio signal. The equivalent complex mask 902 provided by the audio processing operation 1004 may be applied to the time-frequency representation 704 to provide the dereverberation audio signal 108.

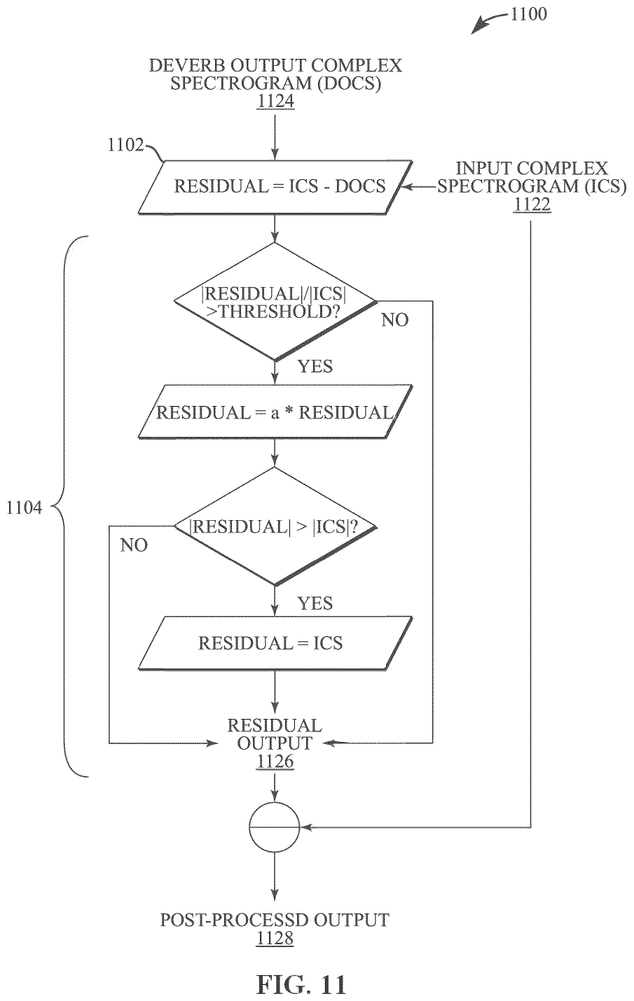

FIG. 11 illustrates an example residual scaling data flow 1100, according to embodiments of the present disclosure. The residual scaling data flow 1100 may provide residual scaling and/or residual clipping for a time-frequency representation of the audio signal 106. For example, rather than training the dereverberation neural network model 110 and/or another model to predict direct speech through multiplication of a mask to input audio, the residual scaling data flow 1100 may predict indirect reverberant content of desirable audio content such as speech and may subtract the indirect reverberant content from an input mixture during inference to achieve optimized dereverberation. For post processing, more aggressive dereverberation may be provided by rescaling residual values.

With the residual scaling data flow 1100, an audio processing operation 1102 may predict a residual based on a difference between a dereverberation output complex spectrogram (DOCS) 1124 and an input complex spectrogram (ICS) 1122. For example, the DOCS 1124 may correspond to the dereverberation audio signal 108 provided based on output of the dereverberation neural network model 110. Additionally, the ICS 1122 may correspond to the audio signal 106. The residual scaling data flow 1100 may also comprise an audio processing operation 1104 that provides a residual output 1126 based on the residual provided by the audio processing operation 1102. For example, given the magnitude of the predicted residual, a scaling factor may be applied when its energy is above a certain threshold value of the input. Energy being above the certain threshold value may imply high energy reflection content. Based on the residual output 1126, the residual scaling data flow 1100 may provide post-processed output 1128. The post-processed output 1128 may correspond to an enhanced and/or fine-tuned audio signal with reduced reverberation.

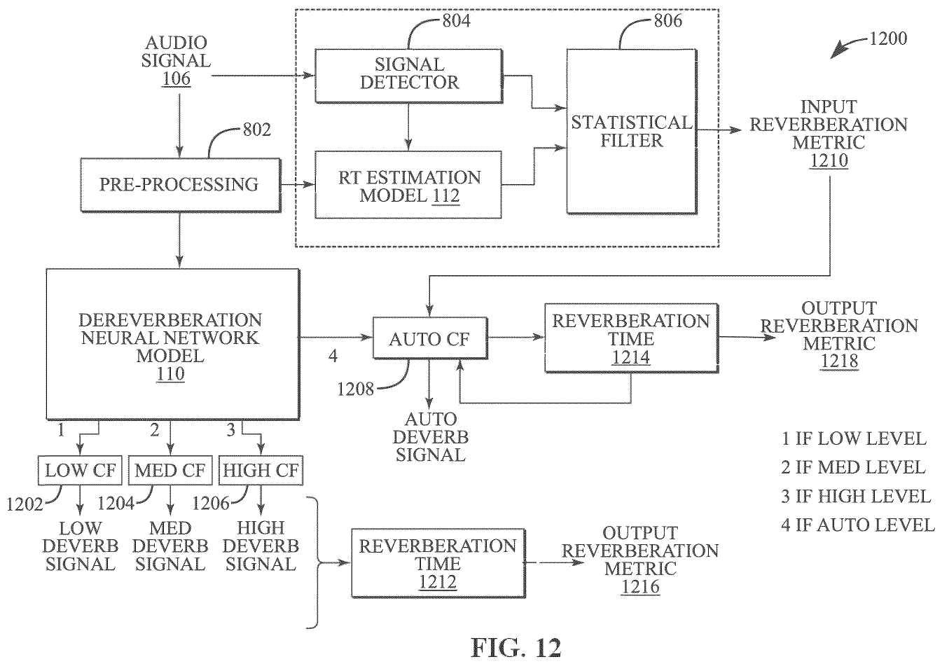

FIG. 12 illustrates an example system 1200, according to embodiments of the present disclosure. The system 1200 may provide a reverberation time prediction and adaptive dereverberation processing for the audio signal 106. For example, the system 1200 may utilize a reverberation time prediction associated with the audio signal 106 to condition a compression factor selection for an equivalent complex mask. The system 1200 includes the pre-processing 802, the signal detector 804, the statistical filter 806, and/or the RT estimation model 112 to enable generation of the reverberation time data 606 for the audio signal 106. Additionally, the system 1200 includes the dereverberation neural network model 110 to enable adaptive dereverberation processing for the audio signal 106.

In some examples, the pre-processing 802 provides an audio feature set for the audio signal 106 as input to the dereverberation neural network model 110 and the RT estimation model 112. The dereverberation neural network model 110 may generate an audio dereverberation mask (e.g., the audio dereverberation mask 308) associated with the audio signal 106 based on the audio feature set provided by the pre-processing 802. The dereverberation neural network model 110 may adaptively configure the audio dereverberation mask based on a compression factor (CF). The CF may comprise a low CF 1202 associated with a first level of dereverberation, a medium CF 1204 associated with a second level of dereverberation, a high CF 1206 associated with a third level of dereverberation, or an auto CF 1208 associated with an automatic level of dereverberation.

The first level of dereverberation for the low CF 1202 may be lower than the second level of dereverberation and the third level of dereverberation. The second level of dereverberation for the medium CF 1204 may be higher than the first level of dereverberation and lower than the third level of dereverberation. The third level of dereverberation for the high CF 1206 may be higher than the first level of dereverberation and the second level of dereverberation.

The auto CF 1208 may dynamically adjust a level of dereverberation applied to the audio signal 106 based on features of the audio feature set for the audio signal 106, parameters provided by the RT estimation model 112, and/or other input parameters for the dereverberation neural network model 110. Additionally, the auto CF 1208 may comprise a mask CF. In some examples, the parameters provided by the RT estimation model 112 may include an input reverberation metric 1210 that characterizes reverberation of the audio signal 106. In some examples, a reverberation time of a processed audio signal (e.g., the dereverberation audio signal 108) may be provided to enable feedback regarding effectiveness of dereverberation for the audio signal 106. For instance, a reverberation time 1212 may be determined for a dereverberation audio signal provided based on the low CF 1202, the medium CF 1204, or the high CF 1206.

Alternatively, a reverberation time 1214 may be determined for a dereverberation audio signal provided based on the auto CF 1208. An output reverberation metric 1216 may also be provided based on the reverberation time 1212 and/or the output reverberation metric 1218 may be provided based on the reverberation time 1214 to enable to provide reverberation information for the audio signal 106 via an electronic interface of a user device.

In some examples, controlling the amount of dereverberation that is applied may be based on estimated reverberation time, direct-to-reverberant ratio (DRR), speech-to-reverberation modulation energy ratio (SRMR), or another control signal related to size/impact of an environment on speech quality. For instance, estimated reverberation time, a DRR estimation, and/or SRMR operations may be standalone as compared to the dereverberation neural network model 110. Alternatively, estimated reverberation time, a DRR estimation, and/or SRMR operations may be integrated into the dereverberation neural network model 110.

In some examples, a room impulse response may be estimated using the input/output relationship from the dereverberation process to determine a degree of reverberation in an environment. If an output of the dereverberation neural network model 110 minus an input of the dereverberation neural network model 110 it determined to include a certain degree of energy, the degree of reverberation in an environment may be considered undesirable.

Post-processing parameters may be controlled depending on the degree of reverberation in the environment. estimated reverberation time, a DRR estimation, and/or SRMR estimates may be collected both before and after the dereverberation neural network model 110 is executed, along with a predetermined empirical relationship of input/output for estimated reverberation time, DRR, or SRMR parameters to the amount of post-processing that is deemed desirable to enable a user specified reverberation time. In some examples, estimated reverberation time, a DRR estimation, and/or SRMR may be utilized to select the dereverberation neural network model 110 from a set of pre-trained dereverberation neural network models for different environment types and/or different environment sizes.

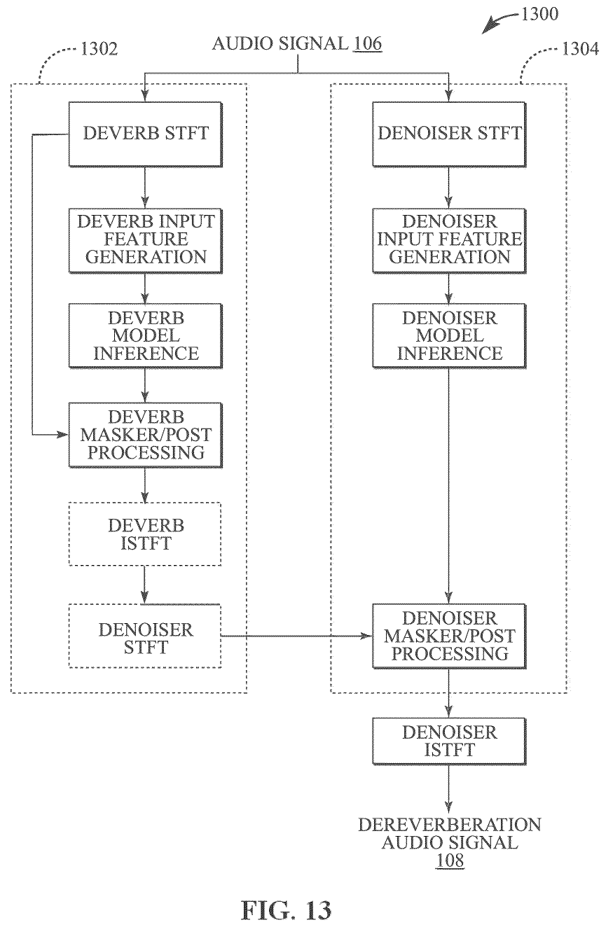

FIG. 13 illustrates an example combined machine learning data flow 1300, according to embodiments of the present disclosure. The combined machine learning data flow 1300 may include a dereverberation machine learning data flow 1302 and a denoiser machine learning data flow 1304. For example, the combined machine learning data flow 1300 may be executed via the model processing loop 304 by utilizing the dereverberation neural network model 110 via the dereverberation machine learning data flow 1302 and utilizing the denoiser neural network model 510 via the denoiser machine learning data flow 1304.

With the combined machine learning data flow 1300, the audio signal 106 may be provided as input to the dereverberation machine learning data flow 1302 and the denoiser machine learning data flow 1304. In the dereverberation machine learning data flow 1302, the audio signal 106 may be processed via a dereverberation STFT operation to transform the audio signal 106 into a time-frequency representation, dereverberation input feature generation to extract relevant features for dereverberation processing, dereverberation model inference associated with the dereverberation neural network model 110, and dereverberation masker/post processing associated with processing of a generated dereverberation mask provided by the dereverberation neural network model 110.

In parallel to the dereverberation machine learning data flow 1302, the audio signal 106 may be processed via a denoiser STFT operation to transform the audio signal 106 into a time-frequency representation, denoiser input feature generation to extract relevant features for denoising processing, denoiser model inference associated with the denoiser neural network model 510, and denoiser masker/post processing associated with processing of a generated denoiser mask provided by the denoiser neural network model 510. The combined machine learning data flow 1300 may conclude with a denoiser ISTFT operation to transform the processed audio signal back into the time domain, resulting in the dereverberation audio signal 108 that is enhanced through both dereverberation and denoising processes.

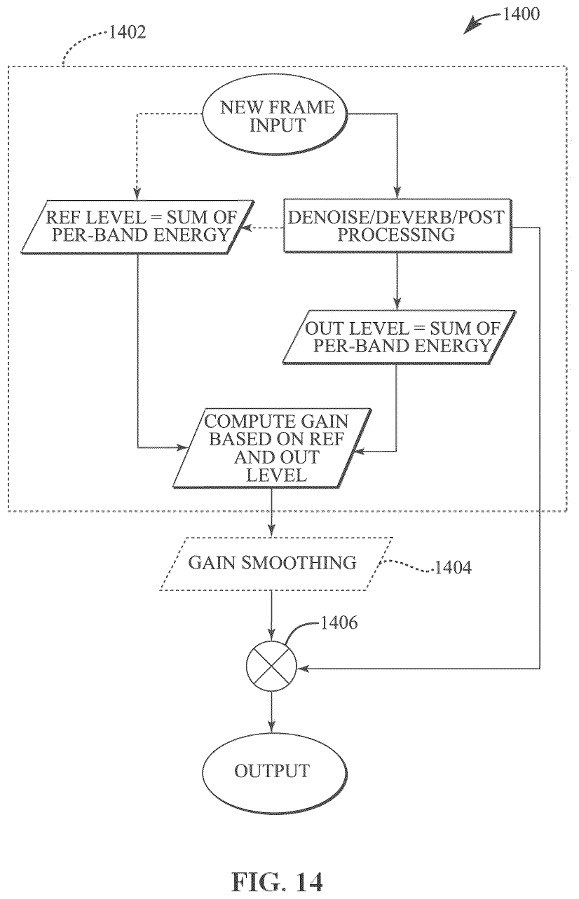

FIG. 14 illustrates an example level compensation data flow 1400, according to embodiments of the present disclosure. For example, the level compensation data flow 1400 may provide a per frame level compensation 1402 for the audio signal 106 since output of the dereverberation neural network model 110 and/or the denoiser neural network model 510 may result in an overall level drop for the dereverberation audio signal 108. To enable per frame level compensation, a per-frame gain may be computed based on a difference between an input level and an output level to compensate for the difference. Gain smoothing 1404 may also be utilized to mitigate abrupt level change in the dereverberation audio signal 108.

The level compensation data flow 1400 may begin with a new frame input that corresponds to a segment of the audio signal 106. With the level compensation data flow 1400, the new frame input may be processed via two parallel processing paths. In the first processing path, a reference level may be calculated as the sum of per-band energy. The reference level may be utilized as a baseline for comparison to maintain consistent audio levels throughout the processing chain. The second processing path may utilize a denoising, dereverberation, and/or post-processing associated with the dereverberation neural network model 110, the denoiser neural network model 510, and/or additional post-processing. The output of the denoising, dereverberation, and/or post-processing may undergo an energy calculation where an output level is computed as the sum of per-band energy.

In some examples, the reference level and output level may be utilized to compute a gain based on a difference between the reference level and output level. The difference may also be utilized to determine a degree of gain adjustment to compensate for any level changes introduced during the denoising and dereverberation processing stages. As such, by comparing the input and output energy levels, the level compensation data flow 1400 may dynamically adjust the gain to maintain consistent perceived level of audio for the dereverberation audio signal 108.

Following the gain computation, the gain smoothing 1404 may be utilized to mitigate abrupt level changes in the dereverberation audio signal 108, thereby improving audio quality for the dereverberation audio signal 108 by mitigating sudden jumps or drops in volume. The smoothed gain may then be applied to the processed signal through a multiplication operation 1406. This multiplication operation 1406 may adjust the level of the processed audio to match more closely with the input level, compensating for any attenuation introduced during the denoising and dereverberation stages. Additionally, the level-compensated signal may be provided as output corresponding to an adjusted dereverberation audio signal 108. The output may provide a more consistent level with the original input while maintaining the benefits from the dereverberation and denoising processes.

In some examples, the level compensation data flow 1400 includes a feedback loop where the output of the denoising, dereverberation, and/or post-processing is utilized for the reference level calculation. This feedback mechanism may allow for adaptive adjustment of the reference level based on the processed signal characteristics, thereby improving the accuracy of level compensation over time or in varying acoustic conditions. As such, by implementing this level compensation approach, the level compensation data flow 1400 may enhance the overall quality of the dereverberation audio signal 108 by mitigating undesirable level fluctuations.

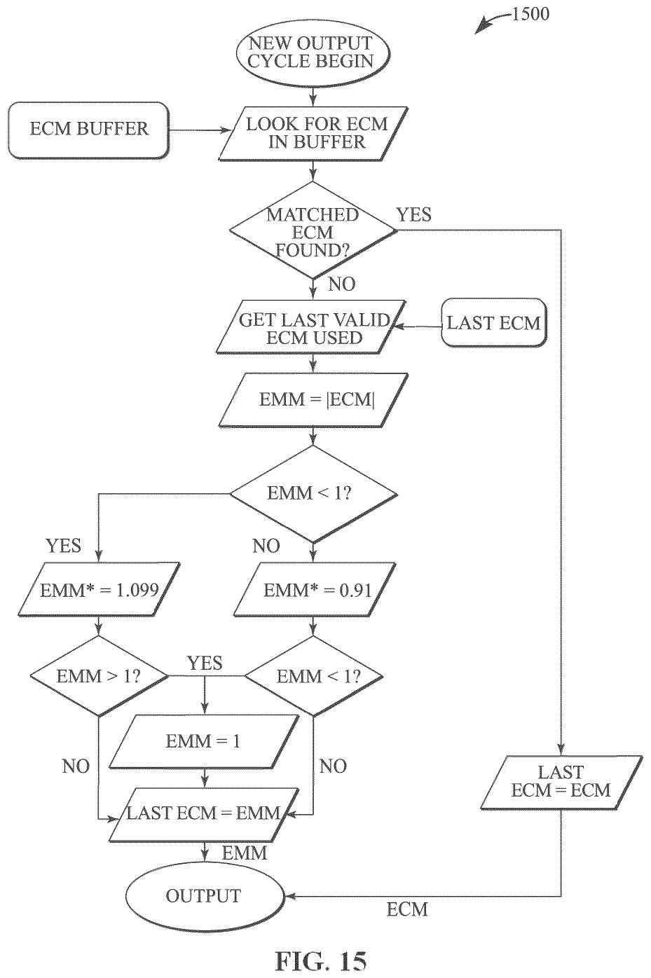

FIG. 15 illustrates an example compensation control data flow 1500, according to embodiments of the present disclosure. The compensation control data flow 1500 may provide computational control of a mask. In some examples, when dropout occurs due to computation overload such that an output mask is not determined in time for multi-threading scenario associated with the model processing loop 304, a previously utilized mask may be utilized and/or masking values may be incrementally increased to 1 over time such that it eventually bypasses the masked audio and/or allows the input audio to pass through. In a scenario for dereverberation processing innovations where a mask is a complex valued ECM, magnitude of a previous valid ECM may be utilized when dropout occurs and/or mask values may be incrementally increased to 1.

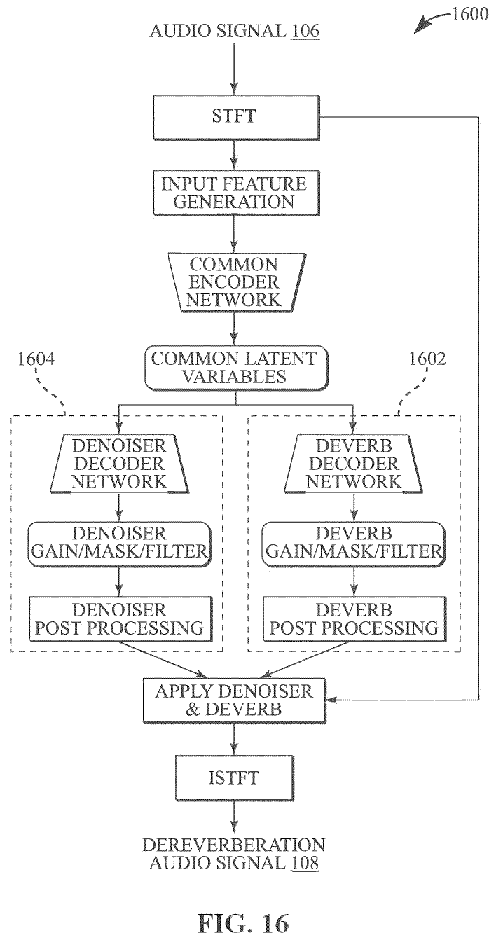

FIG. 16 illustrates an example combined machine learning data flow 1600, according to embodiments of the present disclosure. The combined machine learning data flow 1600 may include a dereverberation machine learning data flow 1602 and a denoiser machine learning data flow 1604. The combined machine learning data flow 1600 may also utilize level control via input provided by a user. In some examples, the combined machine learning data flow 1600 may enable the dereverberation neural network model 110 to incorporate denoising functionality for the audio signal 106 in addition to the dereverberation functionality for the audio signal 106. For instance, the combined machine learning data flow 1600 may enable the dereverberation neural network model 110 to produce masking/filtering for both dereverberation and denoising such that the dereverberation and denoising operations are separate from each other to enable a user to independently control the dereverberation and denoising

With the combined machine learning data flow 1600, the audio signal 106 may be provided as input to a dereverberation STFT operation to transform the audio signal 106 into a time-frequency representation, input feature generation to extract relevant features for dereverberation and denoising processing, and a common encoder network to determine common latent variables for dereverberation and denoising processing. In some examples, the dereverberation neural network model 110 may comprise an autoencoder structure where a single encoder is utilized to produce features and latent space that is useful for both dereverberation and denoising. Additionally, a split decoder may be employed such that a first decoder path associated with the denoiser machine learning data flow 1604 is trained to produce denoising parameters and a second decoder path associated with the dereverberation machine learning data flow 1602 is trained to produce dereverberation parameters.

Each of the outputs from the dereverberation machine learning data flow 1602 and the denoiser machine learning data flow 1604 may be independently selected to apply dereverberation and denoising to the audio signal 106. In some examples, each of the outputs from the dereverberation machine learning data flow 1602 and the denoiser machine learning data flow 1604 may be independently selected and/or altered by a user to control the degree of denoising and/or dereverberation for the audio signal 106. Multiple time/frequency resolutions for the input and output of the dereverberation machine learning data flow 1602 and the denoiser machine learning data flow 1604 may be employed to optimize the effects of dereverberation and denoising. Output masks/filters associated with dereverberation and/or denoising may also be combined into a single time/frequency application or optimized as serial applications to reduce latency.

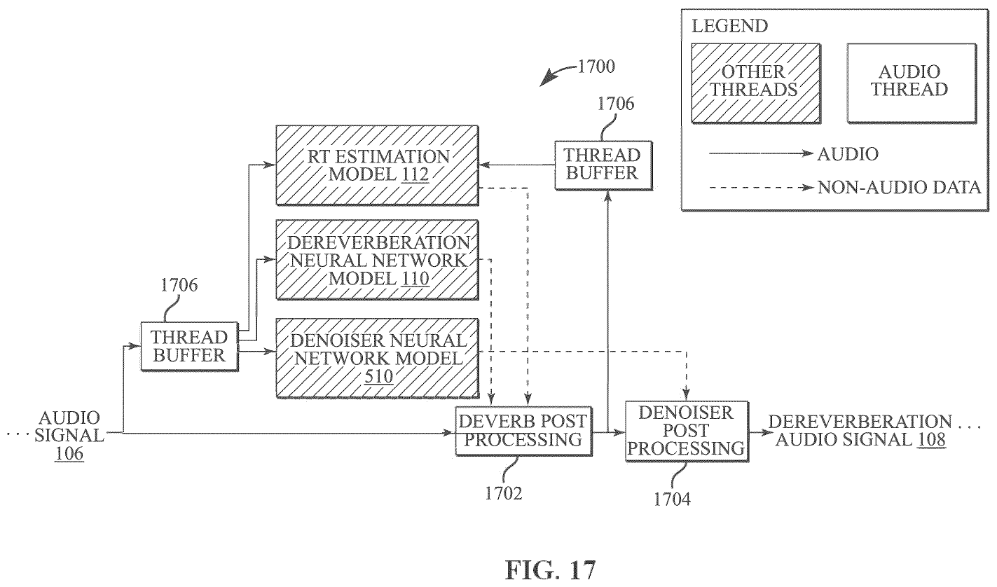

FIG. 17 illustrates an example failsafe system 1700 associated with separate audio threading, according to embodiments of the present disclosure. For example, the failsafe system 1700 may separate a signal path for the audio signal 106 into an in-line application signal processor and a side chain signal path that calculates the desired behavior for the in-line application signal processor. The two processes may be executed on different computational threads such that model computations associated with the dereverberation neural network model 110, the RT estimation model 112, and/or the denoiser neural network model 510 does not impact audio computation for the audio signal 106.

In some examples, separation and threading of the side chain processing may be enabled via atomic processing units executed separately from each other. In some examples, the atomic processing units may be scheduled in a pipelined and/or a parallel implementation to reduce buffering of data. This may also allow for unknown or changing processing time requirements of the audio signal processing system 100 due to other computational factors that are not related to dereverberation (e.g., other digital signal processing, operating system scheduling, etc.). The separation and threading of the side chain processing may also allow for a set latency without accounting for certain processing requirements by allowing the in-line application signal processor to run and apply actual, or estimated, dereverberation operations regardless of a completion time for the associated side chain signal processing.

With the failsafe system 1700, reliability of the audio signal processing system 100 may be enhanced such that consistent audio output is maintained even under varying computational loads. The in-line application signal processor may handle an audio thread for the failsafe system 1700. In some examples, the in-line application signal processor may execute dereverberation post-processing 1702, denoiser post-processing 1704, and/or management of one or more thread buffers 1706 for the dereverberation neural network model 110, the RT estimation model 112, and/or the denoiser neural network model 510. The side chain signal path may handle one or more other threads for the failsafe system 1700. For instance, the side chain signal path may be associated with the dereverberation neural network model 110, the RT estimation model 112, and/or the denoiser neural network model 510. The dereverberation neural network model 110, the RT estimation model 112, and/or the denoiser neural network model 510 may be executed to determine optimal dereverberation and denoising parameters without directly affecting the audio signal flow associated with the in-line application signal processor.

By executing these two processes on different computational threads, the failsafe system 1700 may enable efficient model computations associated with the dereverberation neural network model 110, the RT estimation model 112, and/or the denoiser neural network model 510. This separation may also enable uninterrupted audio output, especially in real-time audio processing applications. In some examples, the thread buffers 1706 may manage the flow of audio data between the main audio thread and the side chain processing threads. The thread buffers 1706 may also act as an intermediary, ensuring that the audio signal 106 is processed continuously while more computationally intensive models operate asynchronously. The dereverberation post-processing 1702 and the denoiser post-processing 1704 associated with the audio thread may apply actual or estimated dereverberation operations based on the most recent data available from the side chain models. As such, audio enhancement for the audio signal 106 may continue even if the side chain processing is temporarily delayed or interrupted during real-time operation.

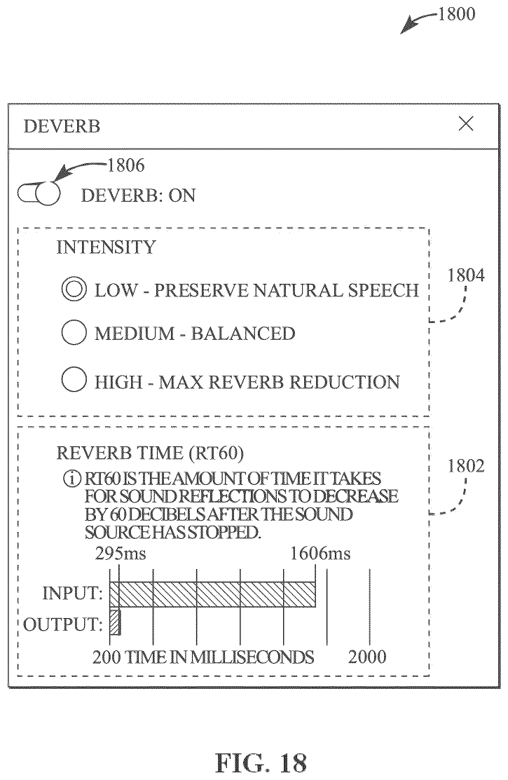

FIG. 18 illustrates an audio processing control user interface 1800 according to embodiments of the present disclosure. The audio processing control user interface 1800 may be an electronic interface (e.g., a graphical user interface) of a user device. For example, the audio processing control user interface 1800 may be a user interface, a web user interface, a mobile application interface, or the like.

The audio processing control user interface 1800 includes a dynamic reverberation time interface 1802. The dynamic reverberation time interface 1802 may visually indicate a degree of dereverberation associated with the audio signal 106. In some examples, the dynamic reverberation time interface 1802 may provide a visualization (e.g., a visual representation) of a dynamic dereverberation data object associated with the audio dereverberation mask 308 and/or the dereverberation audio signal 108 to enable human interpretation of the degree of dereverberation provided by the dereverberation neural network model 110. The dynamic reverberation time interface 1802 may also include graphic representation and/or textual representation of the degree of dereverberation provided by the dereverberation neural network model 110 and/or the RT estimation model 112.

The audio processing control user interface 1800 may also include a user engagement dereverberation interface 1804 to enable determination of the one or more user dereverberation control parameters 404. For example, the user engagement dereverberation interface 1804 may be a dynamic object that may be modified based on feedback provided by a user via the audio processing control user interface 1800. The user engagement dereverberation interface 1804 may include one or more selectable buttons to enable selection of the intensity of the dereverberation provided by the dereverberation system 102. For example, the user engagement dereverberation interface 1804 may include a first selectable button associated with low dereverberation to preserve natural speech in the audio signal 106, a second selectable button associated with medium dereverberation to provide balance audio processing for the audio signal 106, and a third selectable button associated with high dereverberation to provide maximum reverberation reduction for the audio signal 106.

In some examples, the user engagement dereverberation interface 1804 is alternatively configured as a drop-down menu, one or more interface knobs, a slide control interface, or another type of interface element configured to control and/or modify a value of the one or more user dereverberation control parameters 404. In some examples, the user control system 104 and/or the user dereverberation control 402 may apply the one or more user dereverberation control parameters 404 generated via the user engagement dereverberation interface 1804 to the audio dereverberation mask 308 to generate the modified audio dereverberation mask 408. The audio processing control user interface 1800 may also include a user engagement dereverberation interface 1806 to enable dynamic control of the execution of the dereverberation neural network model 110. For example, the user engagement dereverberation interface 1806 may allow a user to turn dereverberation on or off for the audio signal 106.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

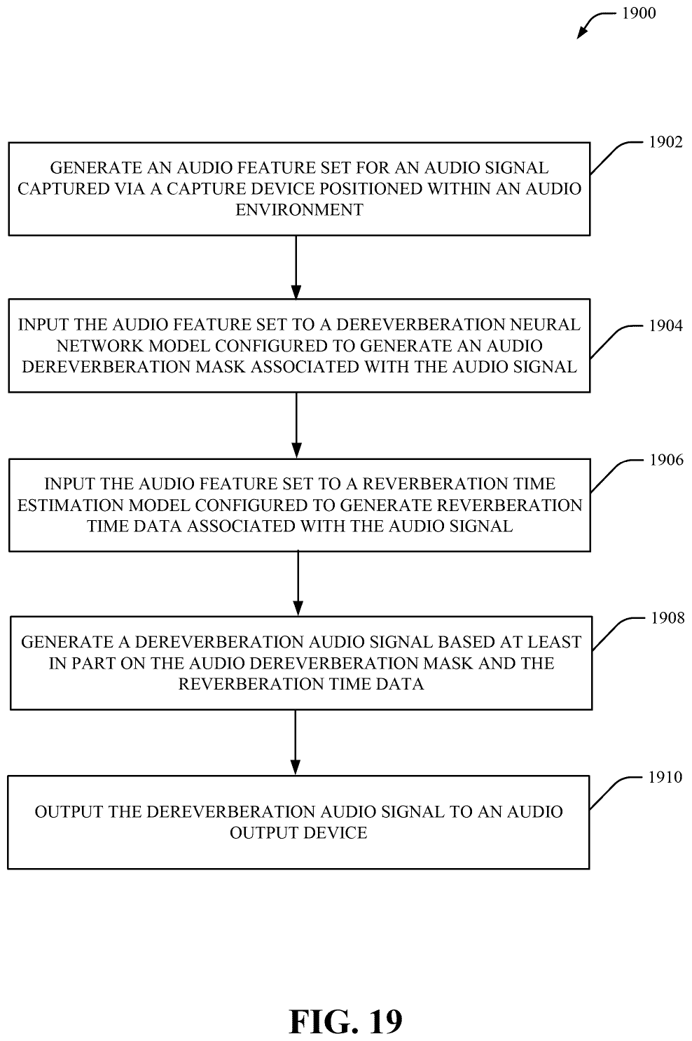

FIG. 19 is a flowchart diagram of an example process 1900 for providing dereverberation for audio signal via machine learning and/or user control, in accordance with, for example, the audio signal processing apparatus 152 illustrated in FIG. 2. Via the various operations of the process 1900, the audio signal processing apparatus 152 may improve accuracy and/or efficiency for reducing reverberation for an audio signal.

At block 1902, a processor (e.g., the processor 204 and/or the ML processing circuitry 158) generates an audio feature set for an audio signal captured via a capture device positioned within an audio environment. The audio feature set may include one or more audio features for the audio signal. The audio feature set may also represent physical features and/or perceptual features related to the audio signal. For instance, the one or more audio features may comprise: one or more: audio spectrum features, magnitude features, phase features, pitch features, harmonic features, MFCC features, performance features, performance sequencer features, tempo features, time signature features, and/or other types of features associated with the audio signal.

The capture device may include one or more sensors configured for capturing audio by converting sound into one or more electrical signals. The audio captured by the one or more capture devices may also be converted into the audio signal. In an example, the capture device includes one or more microphones. For example, the capture device may correspond to a microphone array, one or more microphones of a microphone array, one or more linear microphones of a microphone array, one or more ceiling microphone arrays, one or more table microphone arrays, one or more condenser microphones, one or more MEMS microphones, one or more dynamic microphones, one or more piezoelectric microphones, one or more virtual microphones, one or more network microphones, one or more ribbon microphones, one or more ambisonics microphones, or another type of microphone configured to capture audio. In some examples, the capture device includes a plurality of multi-lobe capture devices. In some examples, the capture device generates and/or utilizes one or more beamformed lobes to enable capture of the audio.

At block 1904, a processor (e.g., the processor 204 and/or the ML processing circuitry 158) inputs the audio feature set to a dereverberation neural network model configured to generate an audio dereverberation mask associated with the audio signal. In some examples, the dereverberation neural network model is a deep neural network. The dereverberation neural network model may be trained based on a feature set associated with audio samples. In some examples, the dereverberation neural network model is trained based on a feature set associated with numerous acoustic spaces. In some examples, the dereverberation neural network model may guide one or more other DSP processes to effectively reduce reverberation and/or to preserve desirable audio (e.g., speech) associated with the audio signal. In some examples, the dereverberation neural network model may inform a series of filters configured to reduce reverberation. In some examples, the filters may be configured to maintain a natural tone of speech by reducing coloration caused by reverberation (e.g., not just a reverberation tail portion of the audio signal 106). In some examples, output of the dereverberation neural network model may be utilized for a magnitude mask to provide more effective mitigation of reverberation.

The audio dereverberation mask may be a time-frequency representation that is applied to the audio signal to reduce or remove reverberation effects of the audio signal. In some examples, the audio dereverberation mask includes gain values for different time-frequency bins of a time-frequency representation (e.g., an audio spectrogram) for the audio signal. In some examples, the audio dereverberation mask may be a magnitude mask, a complex mask, a ratio mask, a filtered mask, or another type of mask.

At block 1906, a processor (e.g., the processor 204 and/or the ML processing circuitry 158) inputs the audio feature set to a reverberation time estimation model configured to generate reverberation time data associated with the audio signal. The reverberation time estimation model may be a reverberation time estimation neural network model or another type of model configured to provide a reverberation time estimation. In some examples, the reverberation time estimation model is a deep neural network. The reverberation time estimation model may be trained based on a feature set associated with audio samples. In some examples, the reverberation time estimation model is trained based on a feature set associated with numerous acoustic spaces. In some examples, the reverberation time estimation model is a reverberation time estimation neural network model and a processor (e.g., the processor 204 and/or the ML processing circuitry 158) input the audio feature set to the reverberation time estimation neural network model to generate the reverberation time data associated with the audio signal.

The reverberation time data may characterize the decay of sound reflections in an acoustic environment. For example, the reverberation time data may include, but is not limited to, estimates of reverberation time values that represent the time required for sound reflections to decrease by a certain degree (e.g., 60 decibels) after the sound source has stopped propagating through the environment. In some examples, the reverberation time data may provide quantitative measures of reverberation characteristics that may be utilized to inform and/or optimize dereverberation processing, adapt filter parameters, and/or provide insights to users regarding acoustic properties of the environment. In some examples, the reverberation time data may be calculated for different frequency bands of the audio signal.

At block 1908, a processor (e.g., the processor 204 and/or the DSP circuitry 160) generates a dereverberation audio signal based at least in part on the audio dereverberation mask and the reverberation time data. The dereverberation audio signal may include audio with minimized or removed reverberation. For example, the dereverberation audio signal may be a dereverberated version of the audio signal such that reverberation is mitigated or removed from the audio signal. In some examples, the dereverberation audio signal 108 may be a full-band audio version of the audio signal with removed or suppressed reverberation, noise, and/or audio artifacts related to undesirable sound. For example, the audio signal may be associated with reverberated audio data and the dereverberation audio signal may be associated with dereverberated audio data. In another example, the audio signal may be associated with reverberated and noisy audio data and the dereverberation audio signal may be associated with dereverberated and denoised audio data.

At block 1910, a processor (e.g., the processor 204 and/or the DSP circuitry 160) outputs the dereverberation audio signal to an audio output device. The audio output device may include one or more of: a speaker, a speaker array, headphones, earphones, a video capture device (e.g., a camera), a codec (e.g., coder-decoder) device, an audio mixer device, a smartphone, a tablet computer, a laptop, a personal computer, an audio workstation device, a wearable device, an augmented reality device, a virtual reality device, a broadcasting device, a recording device, a haptic device, or another type of output device. In some examples, the output device is an output device communicatively coupled to a microphone array that captures the audio signal.

Although the process 1900 depicts a particular sequence of blocks and/or operations, the sequence may be altered without departing from the scope of the present disclosure. For example, some of the blocks and/or operations depicted may be performed in parallel or in a different sequence that does not materially affect the function of the processes. Additionally, such blocks and/or operations may be performed in any of a number of ways, including, without limitation, in the order and manner as depicted and described herein. In some examples, the process 1900 includes some or all blocks and/or operations described and/or depicted. Similarly, it should be appreciated that one or more of the blocks and/or operations of the process 1900 may be combinable, replaceable, and/or otherwise altered as described herein.

Although example processing systems have been described in the figures herein, implementations of the subject matter and the functional operations described herein may be implemented in other types of digital electronic circuitry, or in computer software, firmware, or hardware, including the structures disclosed in this specification and their structural equivalents, or in combinations of one or more of them.

Embodiments of the subject matter and the operations described herein may be implemented in digital electronic circuitry, or in computer software, firmware, or hardware, including the structures disclosed in this specification and their structural equivalents, or in combinations of one or more of them. Embodiments of the subject matter described herein may be implemented as one or more computer programs, i.e., one or more modules of computer program instructions, encoded on computer-readable storage medium for execution by, or to control the operation of, information/data processing apparatus. Alternatively, or in addition, the program instructions may be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium may be, or be included in, a computer-readable storage device, a computer-readable storage substrate, a random or serial access memory array or device, or a combination of one or more of them. Moreover, while a computer-readable storage medium is not a propagated signal, a computer-readable storage medium may be a source or destination of computer program instructions encoded in an artificially-generated propagated signal. The computer-readable storage medium may also be, or be included in, one or more separate physical components or media (e.g., multiple CDs, disks, or other storage devices).

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program may, but need not, correspond to a file in a file system. A program may be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described herein may be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in, special purpose logic circuitry.

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms, such as consisting of, consisting essentially of, comprised substantially of, and/or the like.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

While this specification contains many specific implementation details, these should not be construed as limitations on the scope of any disclosures or of what may be claimed, but rather as description of features specific to particular embodiments of particular disclosures. Certain features that are described herein in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems may generally be integrated together in a product or packaged into multiple products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Hereinafter, various characteristics will be highlighted in a set of numbered clauses or paragraphs. These characteristics are not to be interpreted as being limiting on the invention or inventive concept, but are provided merely as a highlighting of some characteristics as described herein, without suggesting a particular order of importance or relevancy of such characteristics.

Clause 1. An apparatus comprising at least one processor and a memory storing instructions that are operable, when executed by the at least one processor, to cause the apparatus to: generate an audio feature set for an audio signal captured via a capture device positioned within an audio environment.

Clause 2. The apparatus of clause 1, wherein the instructions are further operable to cause the apparatus to: input the audio feature set to a dereverberation neural network model configured to generate an audio dereverberation mask associated with the audio signal.

Clause 3. The apparatus of any one of the foregoing clauses, wherein the instructions are further operable to cause the apparatus to: input the audio feature set to a reverberation time estimation model configured to generate reverberation time data associated with the audio signal.

Clause 4. The apparatus of any one of the foregoing clauses, wherein the instructions are further operable to cause the apparatus to: generate a dereverberation audio signal based at least in part on the audio dereverberation mask and the reverberation time data.

Clause 5. The apparatus of any one of the foregoing clauses, wherein the instructions are further operable to cause the apparatus to: output the dereverberation audio signal to an audio output device.

Clause 6. The apparatus of any one of the foregoing clauses, wherein the instructions are further operable to cause the apparatus to: input the audio feature set to a denoiser neural network model configured to generate an audio denoiser mask associated with the audio signal.

Clause 7. The apparatus of any one of the foregoing clauses, wherein the instructions are further operable to cause the apparatus to: generate the dereverberation audio signal based at least in part on the audio dereverberation mask, the reverberation time data, and the audio denoiser mask.

Clause 8. The apparatus of any one of the foregoing clauses, wherein the instructions are further operable to cause the apparatus to: receive user dereverberation control parameters.

Clause 9. The apparatus of any one of the foregoing clauses, wherein the instructions are further operable to cause the apparatus to: apply the user dereverberation control parameters to the audio dereverberation mask to generate a user-modified dereverberation mask.

Clause 10. The apparatus of any one of the foregoing clauses, wherein the instructions are further operable to cause the apparatus to: generate the dereverberation audio signal based at least in part on the audio dereverberation mask, the reverberation time data, and the user-modified dereverberation mask.

Clause 11. The apparatus of any one of the foregoing clauses, wherein the instructions are further operable to cause the apparatus to: receive the user dereverberation control parameters via an electronic interface of a user device.

Clause 12. The apparatus of any one of the foregoing clauses, wherein the instructions are further operable to cause the apparatus to: input an audio signal sample associated with the audio signal to a time-frequency domain transformation pipeline of a digital signal processing process for a transformation period, wherein the time-frequency domain transformation pipeline is configured to generate a frequency domain version of the audio signal sample.

Clause 13. The apparatus of any one of the foregoing clauses, wherein the instructions are further operable to cause the apparatus to: input the audio signal sample to a deep neural network (DNN) processing loop comprising the dereverberation neural network model configured to generate the audio dereverberation mask associated with the audio signal.

Clause 14. The apparatus of any one of the foregoing clauses, wherein the instructions are further operable to cause the apparatus to: based on the audio dereverberation mask being generated prior to expiration of the transformation period, apply the audio dereverberation mask to the frequency domain version of the audio signal sample to generate the dereverberation audio signal.

Clause 15. The apparatus of any one of the foregoing clauses, wherein the instructions are further operable to cause the apparatus to: convert the audio signal sample into a non-uniform-bandwidth frequency domain representation.

Clause 16. The apparatus of any one of the foregoing clauses, wherein the instructions are further operable to cause the apparatus to: input the non-uniform-bandwidth frequency domain representation of the audio signal sample to the dereverberation neural network model.

Clause 17. The apparatus of any one of the foregoing clauses, wherein the non-uniform-bandwidth frequency domain representation comprises a Bark scale format.

Clause 18. The apparatus of any one of the foregoing clauses, wherein the non-uniform-bandwidth frequency domain representation comprises an Equivalent Rectangular Bandwidth (ERB) format.

Clause 19. The apparatus of any one of the foregoing clauses, wherein the instructions are further operable to cause the apparatus to: input an audio signal sample associated with the audio signal to a time-frequency domain transformation pipeline of a digital signal processing process for a transformation period, wherein the time-frequency domain transformation pipeline is configured to generate a frequency domain version of the audio signal sample.

Clause 20. The apparatus of any one of the foregoing clauses, wherein the instructions are further operable to cause the apparatus to: input the audio signal sample to a deep neural network (DNN) processing loop comprising (i) the dereverberation neural network model configured to generate the audio dereverberation mask associated with the audio signal and (ii) a denoiser neural network model configured to generate an audio denoiser mask associated with the audio signal.

Clause 21. The apparatus of any one of the foregoing clauses, wherein the instructions are further operable to cause the apparatus to: based on the audio dereverberation mask being generated prior to expiration of the transformation period, apply the audio dereverberation mask and the audio denoiser mask to the frequency domain version of the audio signal sample to generate the dereverberation audio signal.

Clause 22. The apparatus of any one of the foregoing clauses, wherein the instructions are further operable to cause the apparatus to: apply post-processing to the audio dereverberation mask to provide further audio processing related to the audio dereverberation mask.

Clause 23. The apparatus of any one of the foregoing clauses, wherein the post-processing comprises additional dereverberation for the audio signal.

Clause 24. The apparatus of any one of the foregoing clauses, wherein the post-processing comprises denoising for the audio signal.

Clause 25. The apparatus of any one of the foregoing clauses, wherein the instructions are further operable to cause the apparatus to: input the dereverberation audio signal to an automixer configured to optimize audio associated with the audio environment.

Clause 26. The apparatus of any one of the foregoing clauses, wherein the audio dereverberation mask is a first audio dereverberation mask, wherein the dereverberation neural network model is a first dereverberation neural network model, and wherein the instructions are further operable to cause the apparatus to: input the audio feature set to a second dereverberation neural network model configured to generate a second audio dereverberation mask associated with the audio signal.

Clause 27. The apparatus of any one of the foregoing clauses, wherein the instructions are further operable to cause the apparatus to: generate the dereverberation audio signal based at least in part on the first audio dereverberation mask, the second audio dereverberation mask, and the reverberation time data.

Clause 28. The apparatus of any one of the foregoing clauses, wherein the instructions are further operable to cause the apparatus to: input the audio feature set and the audio dereverberation mask to a post-filtering model configured to generate an equivalent complex mask associated with the audio signal.

Clause 29. The apparatus of any one of the foregoing clauses, wherein the instructions are further operable to cause the apparatus to: generate the dereverberation audio signal based at least in part on the audio dereverberation mask, the reverberation time data, and the equivalent complex mask.

Clause 30. The apparatus of any one of the foregoing clauses, wherein the instructions are further operable to cause the apparatus to: input the audio dereverberation mask to a discriminator classification model to generate a reverberation prediction associated with the audio signal.

Clause 31. The apparatus of any one of the foregoing clauses, wherein the instructions are further operable to cause the apparatus to: retrain the dereverberation neural network model based at least in part on the reverberation prediction.

Clause 32. The apparatus of any one of the foregoing clauses, wherein the wherein the reverberation time estimation model is a reverberation time estimation neural network model, and wherein the instructions are further operable to cause the apparatus to: input the audio feature set to the reverberation time estimation neural network model to generate the reverberation time data associated with the audio signal.

Clause 33. A computer-implemented method comprising steps in accordance with any one of the foregoing clauses 1-32.

Clause 34. A computer program product, stored on a computer readable medium, comprising instructions that, when executed by one or more processors of an apparatus, cause the one or more processors to perform one or more operations related to any one of the foregoing clauses 1-32.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising at least one processor and a memory storing instructions that are operable, when executed by the at least one processor, to cause the apparatus to:
generate an audio feature set for an audio signal captured via a capture device positioned within an audio environment;
input the audio feature set to a dereverberation neural network model configured to generate an audio dereverberation mask associated with the audio signal;
input the audio feature set to a reverberation time estimation model configured to generate reverberation time data associated with the audio signal;
generate a dereverberation audio signal based at least in part on the audio dereverberation mask and the reverberation time data; and
output the dereverberation audio signal to an audio output device.

2. The apparatus of claim 1, wherein the instructions are further operable to cause the apparatus to:
input the audio feature set to a denoiser neural network model configured to generate an audio denoiser mask associated with the audio signal; and
generate the dereverberation audio signal based at least in part on the audio dereverberation mask, the reverberation time data, and the audio denoiser mask.

3. The apparatus of claim 1, wherein the instructions are further operable to cause the apparatus to:
receive user dereverberation control parameters;
apply the user dereverberation control parameters to the audio dereverberation mask to generate a user-modified dereverberation mask; and
generate the dereverberation audio signal based at least in part on the audio dereverberation mask, the reverberation time data, and the user-modified dereverberation mask.

4. The apparatus of claim 3, wherein the instructions are further operable to cause the apparatus to:
receive the user dereverberation control parameters via an electronic interface of a user device.

5. The apparatus of claim 1, wherein the instructions are further operable to cause the apparatus to:
input an audio signal sample associated with the audio signal to a time-frequency domain transformation pipeline of a digital signal processing process for a transformation period, wherein the time-frequency domain transformation pipeline is configured to generate a frequency domain version of the audio signal sample;
input the audio signal sample to a deep neural network (DNN) processing loop comprising the dereverberation neural network model configured to generate the audio dereverberation mask associated with the audio signal; and
based on the audio dereverberation mask being generated prior to expiration of the transformation period, apply the audio dereverberation mask to the frequency domain version of the audio signal sample to generate the dereverberation audio signal.

6. The apparatus of claim 5, wherein the instructions are further operable to cause the apparatus to:
convert the audio signal sample into a non-uniform-bandwidth frequency domain representation; and
input the non-uniform-bandwidth frequency domain representation of the audio signal sample to the dereverberation neural network model, wherein the non-uniform-bandwidth frequency domain representation comprises a Bark scale format or an Equivalent Rectangular Bandwidth format.

7. The apparatus of claim 1, wherein the instructions are further operable to cause the apparatus to:
input an audio signal sample associated with the audio signal to a time-frequency domain transformation pipeline of a digital signal processing process for a transformation period, wherein the time-frequency domain transformation pipeline is configured to generate a frequency domain version of the audio signal sample;
input the audio signal sample to a deep neural network (DNN) processing loop comprising (i) the dereverberation neural network model configured to generate the audio dereverberation mask associated with the audio signal and (ii) a denoiser neural network model configured to generate an audio denoiser mask associated with the audio signal; and
based on the audio dereverberation mask being generated prior to expiration of the transformation period, apply the audio dereverberation mask and the audio denoiser mask to the frequency domain version of the audio signal sample to generate the dereverberation audio signal.

8. The apparatus of claim 1, wherein the instructions are further operable to cause the apparatus to:
apply post-processing to the audio dereverberation mask to provide further audio processing related to the audio dereverberation mask.

9. The apparatus of claim 8, wherein the post-processing comprises additional dereverberation for the audio signal.

10. The apparatus of claim 8, wherein the post-processing comprises denoising for the audio signal.

11. The apparatus of claim 1, wherein the instructions are further operable to cause the apparatus to:
input the dereverberation audio signal to an automixer configured to optimize audio associated with the audio environment.

12. The apparatus of claim 1, wherein the audio dereverberation mask is a first audio dereverberation mask, wherein the dereverberation neural network model is a first dereverberation neural network model, and wherein the instructions are further operable to cause the apparatus to:
input the audio feature set to a second dereverberation neural network model configured to generate a second audio dereverberation mask associated with the audio signal; and
generate the dereverberation audio signal based at least in part on the first audio dereverberation mask, the second audio dereverberation mask, and the reverberation time data.

13. The apparatus of claim 1, wherein the instructions are further operable to cause the apparatus to:
input the audio feature set and the audio dereverberation mask to a post-filtering model configured to generate an equivalent complex mask associated with the audio signal; and
generate the dereverberation audio signal based at least in part on the audio dereverberation mask, the reverberation time data, and the equivalent complex mask.

14. The apparatus of claim 1, wherein the instructions are further operable to cause the apparatus to:
input the audio dereverberation mask to a discriminator classification model to generate a reverberation prediction associated with the audio signal; and
retrain the dereverberation neural network model based at least in part on the reverberation prediction.

15. The apparatus of claim 1, wherein the reverberation time estimation model is a reverberation time estimation neural network model, and wherein the instructions are further operable to cause the apparatus to:
input the audio feature set to the reverberation time estimation neural network model to generate the reverberation time data associated with the audio signal.

16. A computer-implemented method comprising:
generating an audio feature set for an audio signal captured via a capture device positioned within an audio environment;
inputting the audio feature set to a dereverberation neural network model configured to generate an audio dereverberation mask associated with the audio signal;
inputting the audio feature set to a reverberation time estimation model configured to generate reverberation time data associated with the audio signal;
generating a dereverberation audio signal based at least in part on the audio dereverberation mask and the reverberation time data; and
outputting the dereverberation audio signal to an audio output device.

17. The computer-implemented method of claim 16, further comprising:
inputting the audio feature set to a denoiser neural network model configured to generate an audio denoiser mask associated with the audio signal; and
generating the dereverberation audio signal based at least in part on the audio dereverberation mask, the reverberation time data, and the audio denoiser mask.

18. The computer-implemented method of claim 16, further comprising:
receiving user dereverberation control parameters;
applying the user dereverberation control parameters to the audio dereverberation mask to generate a user-modified dereverberation mask; and
generating the dereverberation audio signal based at least in part on the audio dereverberation mask, the reverberation time data, and the user-modified dereverberation mask.

19. The computer-implemented method of claim 16, further comprising:
inputting an audio signal sample associated with the audio signal to a time-frequency domain transformation pipeline of a digital signal processing process for a transformation period, wherein the time-frequency domain transformation pipeline is configured to generate a frequency domain version of the audio signal sample;
inputting the audio signal sample to a deep neural network (DNN) processing loop comprising the dereverberation neural network model configured to generate the audio dereverberation mask associated with the audio signal; and
based on the audio dereverberation mask being generated prior to expiration of the transformation period, applying the audio dereverberation mask to the frequency domain version of the audio signal sample to generate the dereverberation audio signal.

20. A computer program product, stored on a computer readable medium, comprising instructions that, when executed by one or more processors of an apparatus, cause the one or more processors to:
generate an audio feature set for an audio signal captured via a capture device positioned within an audio environment;
input the audio feature set to a dereverberation neural network model configured to generate an audio dereverberation mask associated with the audio signal;
input the audio feature set to a reverberation time estimation model configured to generate reverberation time data associated with the audio signal;
generate a dereverberation audio signal based at least in part on the audio dereverberation mask and the reverberation time data; and
output the dereverberation audio signal to an audio output device.
